(19) United States
(12) Patent Application Publication
(10) Pub. No.: US 2023/0324119 A1
(43) Pub. Date: Oct. 12, 2023

(54) LYOPHILIZED BEAD MANUFACTURING SYSTEM AND METHODS

(71) Applicant: BioDot, Inc., Irvine, CA (US)

(72) Inventors: David C. Yang, Tustin, CA (US); Debra D. Bowers, San Marcos, CA (US); Robert W. Rich, Boise, ID (US); Brian L. Kirk, Encinitas, CA (US); Anthony V. Lemmo, Chapel Hill, NC (US)

(21) Appl. No.: 18/184,493

(22) Filed: Mar. 15, 2023

Related U.S. Application Data
(60) Provisional application No. 63/269,457, filed on Mar. 16, 2022.
(60) Provisional application No. 63/368,010, filed on Jul. 8, 2022.

(51) Int. Cl. F26B 5/06

(52) U.S. Cl. CPC F26B 5/06

(57) ABSTRACT

The system and method for the creation of lyophilized beads using an automated or semi-automated system. The system can include a dispense head used in conjunction with a fluid system for dispensing a fluid containing a biological container. The dispense head can dispense droplets of fluid into a container containing a liquid coolant such as liquid nitrogen. The coolant can freeze the droplets solid, and you can dispense more beads into the system.

### INCORPORATION BY REFERENCE TO ANY PRIORITY APPLICATIONS

Any and all applications for which a foreign or domestic priority claim is identified in the Application Data Sheet as filed with the present application are hereby incorporated by reference under 37 CFR 1.57.

### BACKGROUND

### Field

This disclosure generally relates to devices, systems, and methods for manufacturing lyophilized beads.

### Description of the Related Art

Biological reagents that are particularly sensitive to changes in temperature may require specific storage conditions to remain bioactive for long periods of time. One method of preserving such reagents is to snap freeze and dehydrate the reagents using a process called lyophilization to create lyophilized beads. Lyophilized beads, also known as lyobeads, are spheres of lyophilized material that can contain a specific volume of material in each unit. Lyophilization can enable long-term storage, including storage at room temperature, for otherwise perishable materials. A common usage of lyophilized beads is in the pharmaceutical and diagnostic industry for capturing reagents, such as those used in assays. Other uses include uses for microfluidics, the encapsulation of bacteria, drug delivery, etc.

### SUMMARY OF THE INVENTION

In some aspects, the techniques described herein relate to a lyobead manufacturing system including: a reagent fluid source containing a fluid; a fluid dispense head configured to dispense a plurality of spherical droplets of the fluid; a fluid line connecting the reagent fluid source with the fluid dispense head; a fluid pressurizing system including a pump or a pressure regulator configured to pressurize the reagent fluid source; a liquid container including a liquid coolant; and a motion system for moving the fluid dispense head in at least two dimensions relative to the liquid container while maintaining a constant height above an upper surface of the liquid coolant.

In some aspects, the techniques described herein relate to a lyobead manufacturing system, wherein the lyobead manufacturing system is configured to dispense the plurality of spherical droplets, each of the plurality of spherical droplets of fluid having a volume from 2 to 50 μL.

In some aspects, the techniques described herein relate to a lyobead manufacturing system or claim 2 further including a chiller configured to adjust a viscosity of the fluid before the fluid reaches the fluid dispense head.

In some aspects, the techniques described herein relate to a lyobead manufacturing system further including a mixer and/or vortexer to homogenize the fluid before the fluid reaches the fluid dispense head.

In some aspects, the techniques described herein relate to a lyobead manufacturing system further including a plurality of fluid dispense heads in communication with the reagent fluid source through a corresponding plurality of fluid lines.

In some aspects, the techniques described herein relate to a lyobead manufacturing system, wherein the fluid dispense head includes a solenoid valve.

In some aspects, the techniques described herein relate to a lyobead manufacturing system, wherein the solenoid valve is configured to open for an open time to create one of the plurality of spherical droplets and close after expiration of the open time.

In some aspects, the techniques described herein relate to a lyobead manufacturing system, wherein the open time is between 133 μsec and 1 sec.

In some aspects, the techniques described herein relate to a lyobead manufacturing system, wherein closing the solenoid valve provides a clean break off of each of the plurality of spherical droplets.

In some aspects, the techniques described herein relate to a lyobead manufacturing system, wherein fluid dispense head includes a dispensing nozzle including an aperture having an aperture diameter from 40 μm to 1.5 mm.

In some aspects, the techniques described herein relate to a lyobead manufacturing system, wherein dispensing nozzle is selected from a plurality of dispensing nozzles having different aperture diameters.

In some aspects, the techniques described herein relate to a lyobead manufacturing system, wherein the dispensing nozzle includes a threaded connection with the fluid dispense head.

In some aspects, the techniques described herein relate to a lyobead manufacturing system, wherein the solenoid valve is connected with the fluid pressurizing system through the reagent fluid source.

In some aspects, the techniques described herein relate to a lyobead manufacturing system, wherein the fluid pressurizing system including of a pneumatic and/or syringe-driven pump.

In some aspects, the techniques described herein relate to a lyobead manufacturing system, wherein the fluid pressurizing system is configured to create a pressure within the lyobead manufacturing system, and the pressure is adjustable between 15 and 300 psi.

In some aspects, the techniques described herein relate to a lyobead manufacturing system, wherein the fluid pressurizing system is connected with the fluid line.

In some aspects, the techniques described herein relate to a lyobead manufacturing system, wherein the liquid coolant includes liquid nitrogen.

In some aspects, the techniques described herein relate to a lyobead manufacturing system, wherein the liquid container is movable along a shuttle between a dispensing area accessible by the fluid dispense head and a loading/unloading area.

In some aspects, the techniques described herein relate to a lyobead manufacturing system, wherein the fluid dispense head is mounted on the motion system and moves in X and Y directions within a horizontal plane relative to the liquid container during dispensing of the plurality of spherical droplets.

In some aspects, the techniques described herein relate to a lyobead manufacturing system further including a well plate including a plurality of wells, the well plate at least partially disposed within the liquid container such that the liquid coolant enters each of the plurality of wells.

In some aspects, the techniques described herein relate to a lyobead manufacturing system, wherein the plurality of wells are through-holes.

In some aspects, the techniques described herein relate to a lyobead manufacturing system, wherein an orifice of a nozzle of the fluid dispense head is at a height above the liquid coolant configured to allow the plurality of spherical droplets to be spherical just prior to a point of entry into the liquid coolant.

In some aspects, the techniques described herein relate to a lyobead manufacturing system, wherein a depth of the liquid coolant within the liquid container is sufficient to freeze the plurality of spherical droplets dispensed from the fluid dispense head without impacting a bottom of the liquid container.

In some aspects, the techniques described herein relate to a lyobead manufacturing system, wherein a height of an orifice of a nozzle of the fluid dispense head above an upper surface of the liquid coolant is sufficient to prevent freezing of the fluid within the fluid dispense head and/or insufficient to allow functionally significant distortion of a droplet shape of the plurality of spherical droplets prior to impact with a surface of the liquid coolant.

In some aspects, the techniques described herein relate to a lyobead manufacturing system, wherein a combination of a height of an orifice of a nozzle of the fluid dispense head above an upper surface of the liquid coolant and a depth of the liquid coolant prevents the plurality of spherical droplets dispensed from the fluid dispense head from impacting a bottom of the liquid container.

In some aspects, the techniques described herein relate to a lyobead manufacturing system, wherein a height of an orifice of a nozzle of the fluid dispense head above an upper surface of the liquid coolant is between 50 and 100 mm.

In some aspects, the techniques described herein relate to a lyobead manufacturing system, wherein the motion system moves the fluid dispense head within a horizontal plane along X and Y directions.

In some aspects, the techniques described herein relate to a lyobead manufacturing system, wherein the motion system moves the fluid dispense head in a Z direction.

In some aspects, the techniques described herein relate to a lyobead manufacturing system, wherein the motion system includes a transverse rail mounted on a pair of side rails oriented orthogonal to the transverse rail.

In some aspects, the techniques described herein relate to a lyobead manufacturing system further including an adjustable height rail mounted on the transverse rail, the fluid dispense head being mounted on the adjustable height rail.

In some aspects, the techniques described herein relate to a lyobead manufacturing system further including a drop camera system configured to measure a diameter of each of the plurality of spherical droplets in midair after being dispensed by the fluid dispense head.

In some aspects, the techniques described herein relate to a lyobead manufacturing system, wherein a stable droplet size of each of the plurality of spherical droplets is adjustable based on tuning a pressure of the fluid pressurizing system and an open time of the fluid dispense head.

In some aspects, the techniques described herein relate to a lyobead manufacturing system, wherein a maximum stable droplet size and minimum stable droplet size of each of the plurality of spherical droplets based on a diameter of a dispensing nozzle of the fluid dispense head.

In some aspects, the techniques described herein relate to a lyobead manufacturing system, further including a control system configured to: adjust the fluid pressurizing system to set a dispensing pressure of the fluid in the fluid dispense head; and move the fluid dispense head along a pathway over the liquid container; and actuate the fluid dispense head to dispense a first fluid droplet into the liquid coolant at a first location along the pathway and actuate the fluid dispense head to dispense a second fluid droplet into the liquid coolant at a second location along the pathway.

In some aspects, the techniques described herein relate to a lyobead manufacturing system, wherein the first fluid droplet and the second fluid droplet are dispensed while moving the fluid dispense head (OTF).

In some aspects, the techniques described herein relate to a lyobead manufacturing system, further including a control system that includes a dispensing control board on the fluid dispense head in communication with a motion control board of the motion system.

In some aspects, the techniques described herein relate to a method 1-36 to dispense a first fluid droplet into a liquid coolant through a first well of a well plate; moving a dispense head along a pathway; and using the lyobead manufacturing system, dispensing a second fluid droplet into the liquid coolant through the first well of a well plate; wherein a delay period between the first fluid droplet entering the liquid coolant and the second fluid droplet entering the liquid coolant is at least sufficiently long to enable the liquid coolant to freeze the first fluid droplet into a first lyobead before the second fluid droplet enters the liquid coolant within the first well of the well plate.

In some aspects, the techniques described herein relate to a method 37, wherein the first fluid droplet and the second fluid droplet are dispensed through a nozzle of the dispense head.

In some aspects, the techniques described herein relate to a method 38, further including: dispensing each of a first plurality of fluid droplets into a corresponding well of a plurality of wells of the well plate while moving the dispense head along the pathway in a first pass.

In some aspects, the techniques described herein relate to a method 39, further including: dispensing each of a second plurality of fluid droplets into the corresponding well while moving the dispense head along the pathway in a second pass.

In some aspects, the techniques described herein relate to a method 40, wherein the delay period applies between dispensing each of the first plurality of fluid droplets and the second plurality of fluid droplets into corresponding wells is sufficiently long to enable the liquid coolant to freeze the first plurality of fluid droplets into lyobeads before the second plurality of fluid droplets enter the liquid coolant.

In some aspects, the techniques described herein relate to a method of manufacturing a lyobead, including: connecting a reagent fluid source with a fluid dispense head by a fluid line; pressurizing a fluid in the fluid line to a pressure; moving the fluid dispense head to a first location; actuating a solenoid in the fluid dispense head to open a dispense valve for an open time to release a first fluid droplet into a liquid nitrogen coolant at the first location, and closing the dispense valve; moving the fluid dispense head to a second location; and actuating the solenoid in the fluid dispense head to open the dispense valve for the open time to release a second fluid droplet into the liquid nitrogen coolant at the second location, and closing the dispense valve; wherein the pressure in the fluid line and the open time of the fluid dispense head are configured to release a stable droplet size from a nozzle of the dispense valve for first and second fluid drops.

In some aspects, the techniques described herein relate to a method 42 further including dispensing the first fluid droplet and the second fluid droplet while moving the fluid dispense head.

In some aspects, the techniques described herein relate to a method 42 and 43, further including dispensing the first fluid droplet and the second fluid droplet while moving the fluid dispense head (OTF).

In some aspects, the techniques described herein relate to a method 42-44, further including the first fluid droplet being dispensed through a first well of a well plate and the second fluid droplet being dispensed through a second well of the well plate.

In some aspects, the techniques described herein relate to a method 45 further including dispensing a third fluid droplet through the first well after at least a delay period sufficient for the first fluid droplet to freeze within the liquid nitrogen coolant.

In some aspects, the techniques described herein relate to a method 42-46, further including adjusting a height of the fluid dispense head above the liquid nitrogen coolant to prevent distortion of the first and second fluid drops.

In some aspects, the techniques described herein relate to a method 42-47, further including adjusting a depth of the liquid nitrogen coolant to prevent the first fluid droplet and the second fluid droplet from impacting a bottom of a container for the liquid nitrogen coolant.

In some aspects, the techniques described herein relate to a method 42-47, further including adjusting a depth of the liquid nitrogen coolant relative to a top of a well plate to facilitate the first fluid droplet and the second fluid droplet entering the liquid nitrogen coolant.

In some aspects, the techniques described herein relate to a method of tuning a stable droplet size volume for a lyobead manufacturing system, the method including: connecting a reagent fluid source with a fluid dispense head by a fluid line; pressurizing a fluid in the fluid line to a pressure; positioning a nozzle of the fluid dispense head relative to a field of vision of a drop camera; actuating a solenoid in the fluid dispense head to open a dispense valve for an open time to release a first fluid droplet into the field of vision and closing the dispense valve; measuring a diameter of the first fluid droplet using the drop camera while in midair; calculating a volume of the first fluid droplet based on the measured diameter of the first fluid droplet; and adjusting a parameter of the lyobead manufacturing system based on a comparison of the calculated volume with a desired volume.

In some aspects, the techniques described herein relate to a method of lyobead manufacturing, including: providing a well plate including a plurality of wells; providing a liquid coolant within each of the plurality of wells; delivering a reagent fluid from a reagent source to a fluid dispense head; and moving the fluid dispense head along a route over each of the plurality of wells and simultaneously dispensing a single droplet of the reagent fluid into the liquid coolant within each of the plurality of wells (OTF); wherein a droplet throughput rate of the fluid dispense head is between 5,000 and 15,000 droplets per hour per channel.

In some aspects, the techniques described herein relate to a method, wherein moving the fluid dispense head includes making multiple passes along the route and dispensing the single droplet of the reagent fluid into each of the plurality of wells per pass.

In some aspects, the techniques described herein relate to a method, wherein a delay period of the fluid dispense head making the multiple passes is at least sufficiently long to enable the liquid coolant to freeze the dispensed single droplets before receiving dispensed single droplets in each of the plurality of wells in subsequent passes.

In some aspects, the techniques described herein relate to a method, wherein a diameter of each of the plurality of wells is from 0.5 to 2 inches.

In some aspects, the techniques described herein relate to a method, wherein a width or diameter of each of the plurality of wells is from 10 to 25 mm in a direction of travel of the fluid dispense head and a width or diameter of each of the plurality of wells is from 5 to 15 mm in a direction transverse to the direction of travel of the fluid dispense head and a stable droplet size of each of the dispensed single droplets is between 2 μL-50 μL.

In some aspects, the techniques described herein relate to a method, wherein a width or diameter of each of the plurality of wells is from 1 to 25 mm in a direction of travel of the fluid dispense head and a width or diameter of each of the plurality of wells is from 1 to 15 mm in a direction transverse to the direction of travel of the fluid dispense head and a stable droplet size of each of the dispensed single droplets is less than 2 μL.

In some aspects, the techniques described herein relate to a method, wherein the fluid dispense head includes a plurality of valves, each of the plurality of valves spaced apart from adjacent one of the plurality of valves by a pitch distance, and the plurality of wells arranged in rows spaced apart by the pitch distance.

In some aspects, the techniques described herein relate to a method, wherein a stable droplet size of each of the dispensed single droplets is between 2 μL-50 μL.

In some aspects, the techniques described herein relate to a method, wherein a nozzle of the fluid dispense head above an upper surface of the liquid coolant and a depth of the liquid coolant prevents the dispensed single droplets dispensed from the fluid dispense head from impacting a bottom of any of the plurality of wells.

In some aspects, the techniques described herein relate to a method, wherein the fluid dispense head moves within along rails in an X-Y coordinate plane.

In some aspects, the techniques described herein relate to a method, further including: removing the well plate and the liquid coolant from a coolant tray; collecting a plurality of frozen droplets from the coolant tray; and freeze drying the plurality of frozen droplets into a plurality of lyobeads.

In some aspects, the techniques described herein relate to a method, wherein a table speed of the liquid coolant is from 10 to 150 mm/sec.

In some aspects, the techniques described herein relate to a method, wherein a drop velocity of the fluid dispense head is from 100 to 3000 mm/sec.

In some aspects, the techniques described herein relate to a method, wherein a droplet ejection frequency is from 2 to 100 Hz.

In some aspects, the techniques described herein relate to a method, wherein the plurality of wells include between 50 and 400 wells.

In some aspects, the techniques described herein relate to a method, wherein a height of a well plate of the plurality of wells and a surface of the liquid coolant is from 10 to 25 mm.

In some aspects, the techniques described herein relate to a method, wherein a width or diameter of each of the plurality of wells is from 1 to 25 mm in a direction of travel of the fluid dispense head and a width or diameter of each of the plurality of wells is from 1 to 15 mm in a direction transverse to the direction of travel of the fluid dispense head.

In some aspects, the techniques described herein relate to a method, wherein a height of a nozzle of the fluid dispense head above a surface of the liquid coolant is from 50 to 100 mm.

In some aspects, the techniques described herein relate to a method, wherein the delay period is between 10 and 90 seconds.

In some aspects, the techniques described herein relate to a method, wherein a delay period of the fluid dispense head making multiple passes is between 10 and 90 seconds.

In some aspects, the techniques described herein relate to a method and 70, wherein the delay period is approximately 90 seconds.

### BRIEF DESCRIPTION OF THE DRAWINGS

FIG. 1 is a block diagram of a lyophilized bead manufacturing system.

FIG. 2 is an embodiment of a lyophilized bead manufacturing system according to a first embodiment.

FIG. 3 shows a work area of the system of FIG. 2.

FIG. 4 shows a shuttle system of the system of FIG. 2 that is used to move a container of liquid coolant relative to the work area.

FIGS. 5A and 5B illustrate dispense heads and nozzles that are used to dispense a fluid used with the system of FIG. 2.

FIGS. 6A and 6B illustrate sets of four dispense heads.

FIG. 7 shows a partial cutaway view of a side of a liquid container system of the system of FIG. 2, including a dispense head dispensing a droplet into a well of a well plate resting within a liquid coolant bath.

FIG. 8 shows a pneumatic pump and a degasser module for use with the system of FIG. 2.

FIG. 9 shows another well plate usable with the system of FIG. 2.

FIGS. 10-13 show movement of a dispense head along a pathway over a well plate while dispensing a droplet into each well of a well plate along the pathway.

FIG. 14 illustrates a first exemplary pathway for the dispense head over a well plate.

FIG. 15 illustrates another pathway for the dispense head over a well plate.

FIG. 16A illustrates a plurality of lyophilized beads formed within each of the wells of a well plate from the top view.

FIG. 16B shows the liquid container with the plurality of lyophilized beads, the well plate having been removed from the liquid container after the liquid coolant has boiled away.

FIG. 17 illustrates a drop camera with a dispense head dispensing a fluid droplet into a view area of the drop camera.

FIG. 18A illustrates a spherical droplet in the field of view of the drop camera.

FIG. 18B illustrates a non-spherical droplet in the field of view of the drop camera.

FIG. 19 illustrates a chart of data from 1,000 sample droplets dispensed from a dispense head and measured by the drop camera with the chart showing drop volume and coefficient of variance (CV).

FIG. 20 illustrates another lyophilized bead manufacturing system, including an enclosure.

FIG. 21 illustrates the system of FIG. 20 with the enclosure removed.

FIG. 22 illustrates a rear view of the system of FIG. 20.

FIG. 23 illustrates a work area of the system of FIG. 20.

FIG. 24 illustrates a dispense head of the system of FIG. 20.

FIG. 25 illustrates another embodiment of a dispense head.

FIG. 26 shows a method of manufacturing a lyobead.

FIG. 27 shows another method of manufacturing a lyobead.

FIG. 28 shows a method of tuning a stable droplet size volume for a lyobead manufacturing system.

FIG. 29 shows another method of manufacturing a lyobead.

Various examples are depicted in the accompanying drawings for illustrative purposes and should in no way be interpreted as limiting the scope of the examples. Various features of different disclosed examples can be combined to form additional examples, which are part of this disclosure.

### DETAILED DESCRIPTION OF THE PREFERRED EMBODIMENT

The various features and advantages of the systems, devices, and methods of the technology described herein will become more fully apparent from the following description of the examples illustrated in the figures. These examples are intended to illustrate the principles of this disclosure, and this disclosure should not be limited to merely the illustrated examples. The features of the illustrated examples can be modified, combined, removed, and/or substituted as will be apparent to those of ordinary skill in the art upon consideration of the principles disclosed herein.

Typical existing lyobead systems use a step-and-repeat dispense methodology that takes approximately 1-3 seconds to eject one lyobead (1200-3600 beads/hour/channel). In contrast, the lyobead manufacturing systems described herein can have various configurations that provide for a high throughput of frozen lyobeads (e.g., 5,000 to 15,000 beads/hour/channel) using on-the-fly (OTF) dispensing. The precise configurations and components for the systems described herein can vary based on various factors, including the rheology of the reagents being dispensed, lyobead volumes, and other factors, including those in the exemplary configurations described herein.

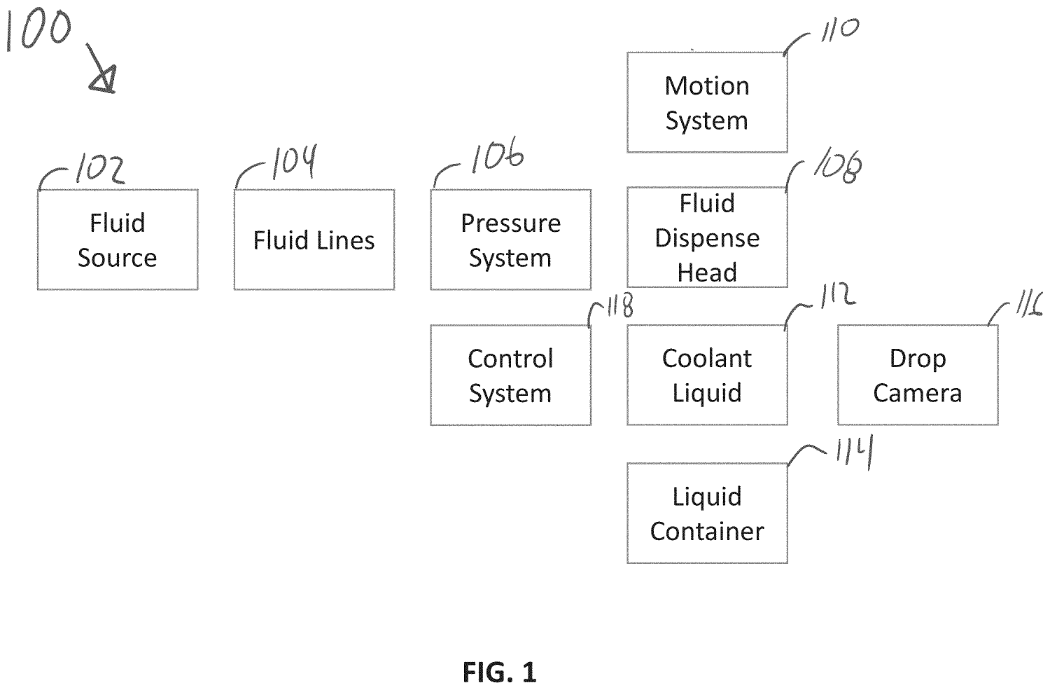

FIG. 1 illustrates a system 100 in a block diagram format. The system 100 is configured for lyophilized bead manufacturing. The system 100 can include a fluid source 102. The fluid source 102 can include a reagent fluid. In some embodiments, the reagent fluid can contain biological material. In some embodiments, the fluid contained within the fluid source 102 can be a biological material that is sensitive to changes in temperature and/or requires specific storage conditions to remain bioactive. Accordingly, the reagent fluid can be treated using a lyophilization process to preserve the materials within the fluid. The system 100 can be used to form the fluid into a plurality of lyophilized beads with each bead having approximately the same volume.

The fluid source 102 can comprise a bottle or other fluid container. In some embodiments, the fluid source 102 can be used in conjunction with a degassing module, a vortexer for homogenizing the fluid, or another fluid treatment apparatus. In some embodiments, the fluid source 102 can be used in conjunction with a chiller or a heater. The chiller or the heater can be used to adjust a temperature of the fluid within the fluid source 102 and/or as the fluid from the fluid source 102 proceeds through the system 100. Changing the temperature of the fluid changes the viscosity of the fluid.

Processing the fluid through the system 100 can be based on the viscosity of the fluid. For example, forming spherical droplets with the system is easier with fluids that have a higher viscosity. Similarly, materials with a lower viscosity can be more difficult to form into spheres having a consistent volume and/or without trailing drops. Accordingly, for some fluid materials, increasing the viscosity of the fluid using a chilling process can be useful. In certain examples, the fluid can have a viscosity of 5 cP (e.g., 50% glycerol, between 20°-30° C.) or 22.5 cP (e.g., 70% glycerol, at 20° C.). In certain examples, the fluid can have a viscosity from 0.91 to 14.6 cP (e.g., 50% glycerol, depending on temperature) or from 1.93 to 76 cP (e.g., 70% glycerol, depending on temperature). In certain examples, the system 100 includes a syringe pump, as will be discussed below, and the fluid can have a greater viscosity (e.g., 0 cP up to 400 cP).

The system 100 can include one or more fluid lines 104. The one or more fluid lines 104 can connect to the fluid source 102. The one or more fluid lines 104 transport the fluid from the fluid source 102 to other components of the system 100. In some configurations, the fluid lines 104 can include poly tubing or generally chemically inert tubing for transporting the fluid from the fluid source 102 to other components of the system 100.

The system 100 can include a fluid pressurization system 106. The fluid pressurization system 106 can include a pump or a pressure regulator, such as a pneumatic pump or a syringe pump. The pump of the fluid pressurization system 106 can be an electric pump. Accordingly, the pump can be electrically controlled. The fluid pressurization system 106 can adjust a pressure of the fluid delivered to other components of the system 100 from the fluid source 102. The fluid pressurization system 106 can be used to adjust a pressure of the fluid within the fluid lines 104 and/or delivered to a fluid dispense head 108. The fluid pressurization system 106 can be adjustable to a set pressure or to a range of pressures (e.g., between a minimum pressure and a maximum pressure). The fluid pressurization system 106 can be used instead of a volumetric-based dispensing system, such as a system using a volumetric pump (e.g., a syringe pump) that delivers a predetermined volume of fluid. The fluid pressurization system 106 can be used to deliver the fluid at the preset pressure or within the preset pressure range. Desirably, the pressure is adjustable to be more than 14.7 and up to 300 psi.

The system 100 can include at least one fluid dispense head 108. Where there is more than one fluid dispense heads 108, the fluid dispense heads 108 can be assembled together in a line, a row, a column, or an array. Each of the plurality of fluid dispense heads 108 can be connected to the fluid source 102 with a respective one of the one or more fluid lines 104 The fluid lines 104 can be fluidly connected with the fluid dispense head 108 to deliver the fluid from the fluid source 102 to the fluid dispense head 108. In some configurations, the fluid pressurization system 106 can connect directly with the fluid dispense head 108 to pressurize the fluid passing through the fluid dispense head 108.

The fluid dispense head 108 can be configured to dispense individual droplets of the fluid. The droplets dispensed from the fluid dispense head 108 can be spherical or nearly spherical when dispensed.

The fluid dispense head 108 can comprise an actuatable valve. The valve can be opened and closed. In some configurations, the valve can be a solenoid valve that opens and closes by actuating a solenoid. The solenoid valve can be configured to open for an open time to create the fluid droplet and to close after expiration of the open time. Closing of the solenoid valve can provide a clean break-off of the fluid droplet formed at the valve opening. Desirably, the open time of the valve can be between 133 μsec and 1 sec.

The fluid dispense head 108 can be configured to dispense individual droplets of fluid at specific volumes based on adjustment of the pressure of the fluid pressurization system 106 and the amount of time that the valve of the fluid dispense head 108 is open. Additional factors may also include the viscosity of the fluid. Tuning the pressure within the fluid lines 104 and the opening of the valve of the fluid dispense head 108 can be used to create droplets at a specified or desired volume. In some embodiments, the fluid dispense head 108 can eject droplets at a velocity within a range of 100 mm/sec to 3000 mm/sec. In some embodiments, the fluid dispense head 108 can eject droplets at a frequency within a range of 2 Hz to 100 Hz.

The valve can include a tip. The tip can be formed of any suitable type of material keeping in mind performance characteristics for the particular application. The materials of the tip can influence how the dispensed droplets shear from the tip. For certain rheologies of fluid, hydrophobic materials, such as poly-ether ether ketones (PEEK), or hydrophilic materials, such as stainless steel, can be used to aid in cleanly shearing droplets from the tip.

The fluid dispense head 108 can also include a nozzle. The nozzle can be removable. Each of the nozzles can include a connector, such as a threaded connector, that is used to attach to the fluid dispense head 108. The fluid dispense head 108 can be used in conjunction with the differently sized nozzles. Nozzles having different orifice sizes can be used in conjunction with the dispense head 108 depending on the desired volume of the dispensed droplets. A diameter of the orifice of the nozzle can correspond to a maximum diameter of a spherical droplet size that can be emitted from the dispense head 108 when used with each dispensing nozzle. Desirably, the orifice diameters of the nozzles can range between 40 μm and 1.5 mm.

The system 100 can include a motion system 110. The motion system 110 can include a mount location for the dispense head 108. When mounted to the mount location, the dispense head 108 is movable over a work area of the system 100. The motion system 110 can be configured to move the dispense head 108 along at least two dimensions. In some embodiments, the motion system 110 is movable in an X-Y coordinate system with X being a width of the work area and Y being a length of the work area. In some embodiments, the motion system 110 also can be movable in a Z-direction. In such embodiments, the motion system 110 can control an adjustable height for the dispense head 108. In some configurations, the height of the dispense head 108 can be adjusted separately of the motion system 110. In the illustrated configuration, adjusting the height of the motion system 110 in a vertical direction over the work area can adjust a height of the fluid dispense head 108 over the work area.

The motion system 110 can comprise two parallel rails aligned in the X-direction. The motion system 110 can comprise a transverse rail mounted on the parallel rails and oriented in the Y-direction. The transverse rail can be movable along the parallel rails. The dispense head 108 can be movable along the transverse rail. The dispense head 108 can additionally be movable along a vertically oriented rail on the transverse rail. The motion system 110 can be actuatable via the use of one or more motors, stepper motors, encoders, linear actuators, or other apparatus known in the art.

The fluid dispense head 108 can move within a horizontal plane in the X and/or Y directions. The fluid dispense head 108 can move along the X direction and/or Y direction with a speed within the range of 10 mm/sec to 150 mm/sec. In some embodiments, the dispense head 108 can be moved closer to and further away from the liquid coolant during OTF dispensing. In some configurations, the fluid dispense head 108 moves at a constant height above the liquid coolant during OTF dispensing. In such applications, the system 100 operates more quickly by eliminating movement of the fluid dispense head 108 towards and away from the liquid coolant. A height of the nozzles above the liquid coolant desirably is great enough that a dispensed fluid does not freeze at the tip and the tip is not cooled by the liquid coolant such the fluid is frozen within the tip.

As discussed directly above, the system 100 can include a liquid coolant 112. The liquid coolant can be contained within a tray or other liquid container 114. The liquid coolant 112 can be poured into the liquid container 114. In some embodiments, the liquid coolant 112 is liquid nitrogen. The liquid coolant 112 can be a sufficiently cold liquid that enables the droplets dispensed from the fluid dispense head 108 to quickly freeze.

The liquid container 114 can be located in the work area of the system 100. The work area can include a shuttle for moving the liquid container 114 to aid in loading/unloading of the liquid coolant 112 and/or the lyobeads formed therein. The work area can also include one or more insulation members for insulating other components of the system 100 from the liquid coolant 112 as this may damage certain mechanical components.

During operation of the system 100, the liquid container 114 can be positioned below at least a region that is accessible by the fluid dispense head 108 using the motion system 110. The liquid container 114 can be a tray, including a sidewall and bottom surface for containing the liquid coolant 112. The liquid container 114 can be generally open along an upper side thereof to provide access for dispensed droplets from the fluid dispense head 108 to enter the liquid coolant 112.

The liquid container 114 can be used in conjunction with a well plate. The well plate can be a generally planar member that is positioned within or above the liquid container 114. In some configurations, the well plate is at least partially submerged within the liquid coolant 112. In other words, in some configurations, the liquid coolant has an upper surface that is above a lower surface of the well plate. The well plate can comprise a plurality of wells that are open on an upper surface of the well plate. The plurality of wells can be open on a lower surface of the well plate to allow the liquid coolant to disperse throughout all of the wells. In some configurations, the plurality of wells can be defined by through-holes. In some configurations, the liquid coolant 112 can be poured into each well separately and each well can be a blind hold such that each well includes a bottom surface. In some configurations, a mix of blind holes and through holes can be provided.

Contact between unfrozen droplets can result in undesirable merging of droplets into non-spherical shapes. Accordingly, the plurality of wells can isolate single droplets as the droplets freeze. After a first droplet has frozen, additional droplets can be added within each well (i.e., one at a time with sufficient time between to allow freezing). Accordingly, the wells can each have a diameter that is large enough that they can contain multiple frozen droplets therein and lower the risk of new unfrozen droplets striking frozen droplets.

The well plate can include at least a minimum number of wells that facilitate a high throughput of lyobead production while still enabling full freezing of each droplet before the fluid dispense head 108 returns to each well to eject a subsequent droplet. Desirably, the well plate can include between 50 and 400 wells.

The wells of the well plate can have dimensions that can retain multiple beads and provide a target size that can be hit with a high degree of accuracy during OTF dispensing. Desirably, the wells can have openings with a diameter within a range of 0.5 inch to 3 inches or a range of 1 inch to 2 inches. Desirably, the wells can have a width (e.g., in the Y direction or the direction transverse to the direction of motion of the dispense head 108 during dispensing) between 5 mm and 15 mm for μL lyobeads. Desirably, the wells can have a length (e.g., in the X direction or in the direction of motion of the dispense head 108 during dispensing) between 10 mm and 25 mm for μL lyobeads. Desirably, the wells can have a width (e.g., in the X direction or transverse to the direction of motion of the dispense head 108 during dispensing) between 1 mm and 15 mm. Desirably, the wells can have a length (e.g., in the Y direction or in the direction of motion of the dispense head 108 during dispensing) between 1 mm and 25 mm. The later set of ranges can include lyobeads having volumes measured in the nanoliter range (e.g., 1-999 nanoliters).

The motion system 110 can move the fluid dispense head 108 over each of the wells of the well plate to dispense a droplet within each of the wells, using an on-the-fly motion (e.g., dispensing without stopping motion of the fluid dispense head 108).

The system 100 can include a drop camera 116. The drop camera 116 can take video and or still pictures within a field of view. The drop camera 116 can be connected to a computer. In use, the dispense head 108 can dispense droplets into the field of vision of the drop camera 116. The drop camera 116 can detect the droplets and measure a diameter or other aspect of the droplets. Based on each of the diameters or other measurements, a volume of each the droplets can be estimated or predicted. The drop camera 116 can be used to adjust the system 100 so that droplets containing the desired volume are emitted by the fluid dispense head 108. For example, the pressure of the fluid pressurization system 106 can be raised or lowered, and/or the open time of the solenoid of the fluid dispense head 108 can be raised or lowered, to provide a stable drop volume with the volume falling within the desired range. The volume of the droplets can determine the size of the lyophilized beads. In some configurations, the volume of the droplets can be between 2 μL-50 μL. In some configurations, the volume of the droplets can greater than 30 μL. In some configurations, a 50 μL droplet can have a diameter between about 4500 μm and about 5000 μm. In some configurations, the volume precision can be <3% CV. In some configurations, the droplets can be generated with orifices that have diameters between 508 μm and 1016 μm. In some configurations, the droplets be generated with orifices that can have diameters of about 508 μm, about 762 μm, or about 1016 μm. Typically, the diameter of any droplet generated by an orifice will be larger than the diameter of the orifice. Additionally, the drop camera 116 can be used to ensure that the droplets being ejected from the dispense head 108 are spherical or close thereto. The pressure of the fluid pressurization system 106 and/or the open time of the dispense head 108 can be adjusted to provide the spherical droplets.

The system 100 can include a control system 118. The control system 118 can be used to control actuation of the fluid dispense head 108, the fluid pressurization system 106, the dispense head 108, the motion system 110, or any of the components of the system 100. The control system can include a processor and a memory including instructions that, when executed by the processor, control the various components of the system 100. Certain components, such as the fluid dispense head 108 and/or fluid pressurization system 106, can include onboard motion control board stacks as part of the control system 118.

According to one methodology, the control system 118 can use the motion system 110 to move the fluid dispense head 108 to a first location. The first location can correspond to a first well of the well plate. The control system 118 can actuate the solenoid in the fluid dispense head 108 to open the valve for the open time to release a first fluid droplet into the liquid coolant 112 at a first location. After dispensing the first fluid drop, the motion system 110 can move the fluid dispense head 108 to a second location. The second location can correspond to a second well of the well plate. The control system 118 can actuate the solenoid in the fluid dispense head 108 to open the dispense valve for the open time to release a second fluid droplet into the liquid coolant 112 at the second location. The control system 118 can dispense the first fluid droplet and/or the second droplet while continually moving the fluid dispense head 108. Desirably, an exemplary throughput of the system 100 can be from 5,000 beads per hour to 15,000 beads per hour with a single dispense nozzle (channel).

According to another method, the first fluid droplet is dispensed into the first location. The motion system 110 moves the fluid dispense head 108 to the second location and then the control system 118 moves the fluid dispense head 108 back to the first location. Upon returning to the first location a third droplet is dispensed at the first location. The time period between the dispensing of the first droplet and the dispensing of the third droplet can be based on a time sufficient for the first fluid droplet to freeze within the liquid coolant 112. After the first droplet has frozen, the next droplet can be dispensed into that same location because the next droplet will not change sizes upon contact with the first drop or break apart the first drop or otherwise become unusable. In some configurations, the frozen fluid droplets float in the liquid coolant after freezing. The frozen fluid droplets can disperse against the sides of the wells against or near the inner surfaces of the wells because of the turbulent motion of the liquid coolant 112 as it boils in room temperature air. Accordingly, the next droplet can be dispensed at or near the center of the wells after the set period of time (e.g., between 10 and 90 seconds).

Another aspect of the method can relate to adjusting a height of an orifice of the fluid dispense head 108. The height of the orifice can be measured above an upper surface of the liquid coolant 112. The height can be between a maximum height above which the droplets being expelled may change shape out of a general near-sphere shape. Desirably, the height can be between 0 and 100 mm, or between 30 mm and 100 mm. Above the max height, the droplets can pancake or otherwise distort. Below the minimum height, fluid in the fluid dispense head 108 is too close to the liquid coolant 112 and can could freeze when still contained with the fluid dispense head 108. As such, the height of the orifice of the fluid dispense head 108 can be set to be a sufficient height above an upper surface of the liquid coolant to avoid freezing of the fluid within the orifice or another portion of the fluid dispense head 108. In some configurations, the height will change over a dispensing operation as the liquid coolant boils off in room temperature air and thereby lowers the upper surface of the coolant during a decreasing volume of liquid coolant within the liquid container 114.

According to another aspect of the method, the depth of the liquid coolant 112 needs to be sufficient in that the droplets dispensed do not impact a bottom of the liquid container 114. In other words, sufficient liquid coolant 112 should remain within the liquid container 114 to reduce the likelihood of, or preferably prevent, an impact of a fluid drop and a bottom surface of the liquid container 114 and also sufficient liquid so that the dispense droplets freeze within a reasonable amount of time. In some configurations, a supply of the liquid coolant can be replenished over time. In some configurations, a level of the upper surface of the liquid coolant can be tracked or a time of operation can be tracked to reduce the likelihood of a depth of liquid coolant within the liquid container decreasing to a level that would allow for the impact of the fluid droplets and the bottom surface of the liquid container during an ongoing fluid droplet dispensing operation.

According to another aspect, a first fluid droplet is dispensed into the liquid coolant 112 using the fluid dispense head 108 through a first well of the well plate. A second fluid droplet is dispensed into the liquid container 114 through the first well of the well plate. A time period between the first fluid droplet entering the liquid coolant 112 and the second fluid droplet entering the liquid coolant 112 is sufficient to enable the liquid coolant to freeze the first fluid droplet before the second fluid droplet enters the liquid coolant. In certain implementations, the time period can vary from 10 to 90 seconds or can be about 90 seconds.

According to another aspect, the fluid dispense head 108 can move along a pathway. between dispensing the first fluid droplet and the second fluid droplet whereby the first fluid droplet is dispensed on a first pass along the pathway and the second fluid droplet dispensed on a second pass along the pathway. This system can also be repeated not just for an individual well but for each the utilized wells of the well board or a subset thereof. When moving along the pathway on the first pass, the fluid dispense head 108 can dispense in each of the wells. And then, when moving along the fluid pathway for the second pass, another droplet can be dropped into each of the wells wherein a delay period between the first droplet being dropped and the second droplet being dropped in each of the wells is sufficient to enable the liquid coolant to freeze the first droplets before the second droplets into the liquid coolant 112. The period between passes of the fluid dispense head 108 along the route can correspond to the movement along the pathway using on-the-fly motion.

According to additional aspects, the method of dispensing the fluid droplets for forming the lyophilized beads can include adjusting the height of the fluid dispense head 108 to reduce or elimination unsatisfactory distortion of the first and second fluid droplets by correcting a height of the fluid dispense head 108 such that the fluid dispense head is unlikely to become too high or too low relative to the upper surface of the liquid coolant for the reasons discussed above. A depth of the liquid coolant can be adjusted as an alternative or in addition to adjusting a height of the fluid dispense head if the liquid coolant becomes too shallow or if the upper surface of the liquid coolant is too high, which may be from limitations of the height adjustment in the Z direction of the fluid dispense head 108. In some configurations, the entire liquid container or a portion of the liquid container can move in the Z direction to adjust a relative height between the upper surface of the liquid coolant and the fluid dispense head 108 and/or a relative height between a bottom surface of the liquid container and the dispense head 108.

A method of tuning the stable droplet size for the lyophilized bead manufacturing system can include connecting a reagent fluid source with the fluid dispense head 108 by the fluid lines 104, providing a pressure into the fluid lines 104 using a fluid pressurization system 106, positioning a nozzle on the fluid dispense head 108 above the field of vision of a drop camera 116, actuating the solenoid of the fluid dispense head 108 using the control system 118 to open the fluid dispense head 108 and releasing a fluid droplet into the field of view of the drop camera 116, capturing an image of at least one dimension of the first fluid droplet using the drop camera 116, measuring the at least one dimension based on the image of the first fluid drop, calculating a volume of the first fluid droplet based on the at least one dimension, and/or adjusting either the open time of the fluid dispense head 108 and/or the fluid pressurization system 106 to adjust the volume of subsequent dispensed droplets. In this manner, the volume of the droplets ejected can be adjusted. In some configurations, the volume of the ejected droplets may be limited by the nozzle size. Accordingly, if a bigger or smaller droplet is needed, nozzle sizes can be changed as part of this process. Additionally, the viscosity of the fluid can be adjusted (e.g., by chilling or heating), which also can impact the ability to eject spherical droplets of a suitable or desired volume.

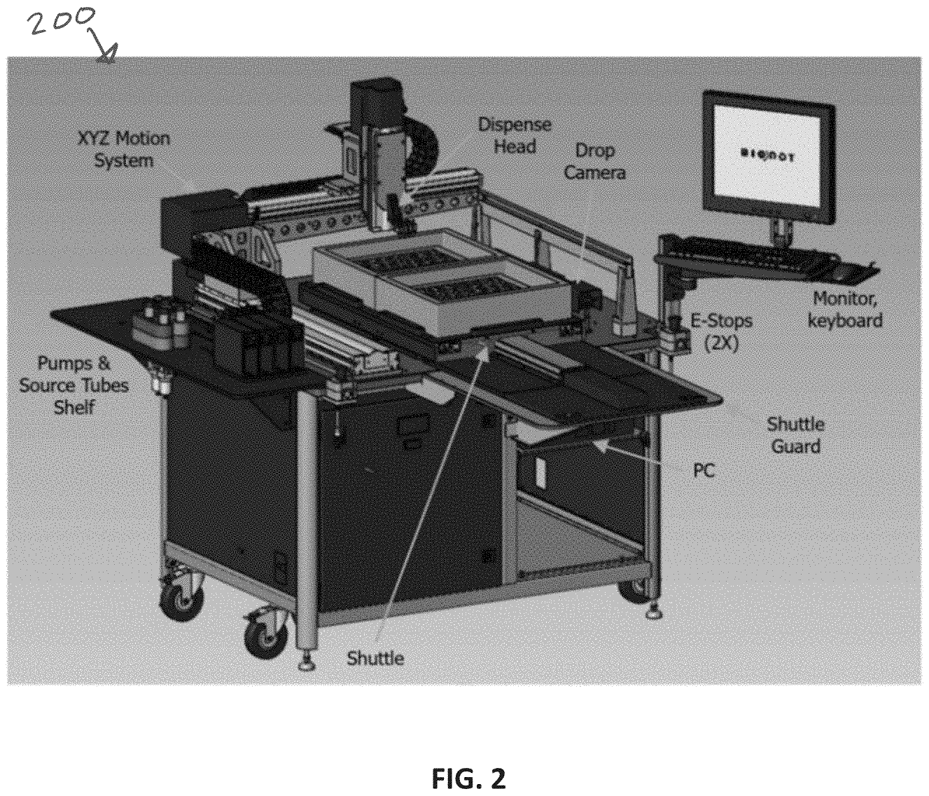

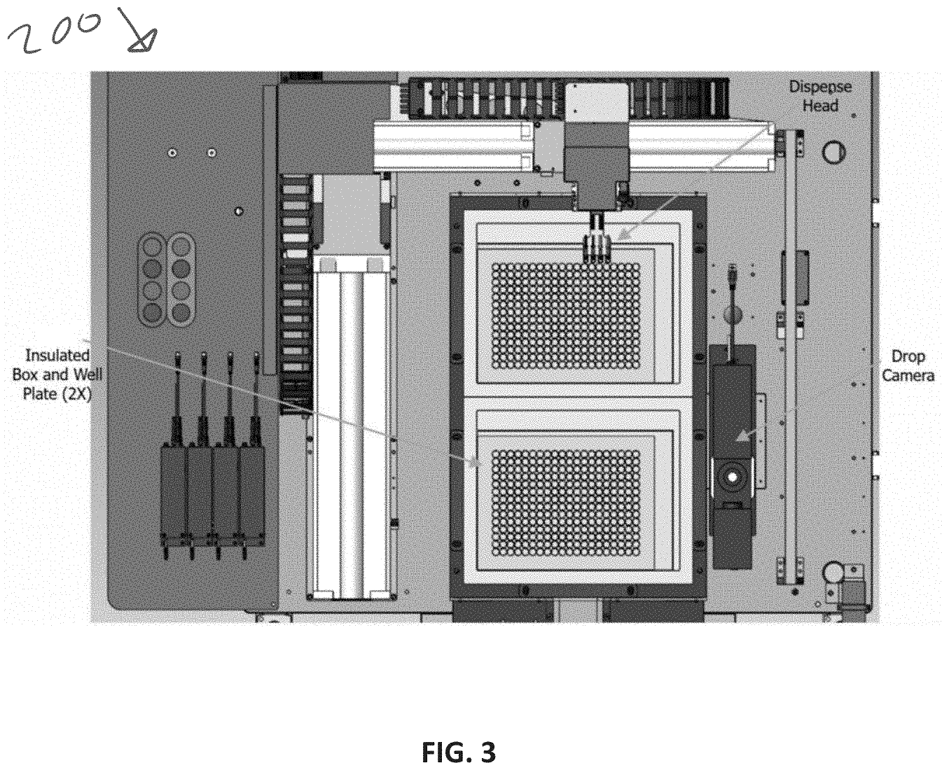

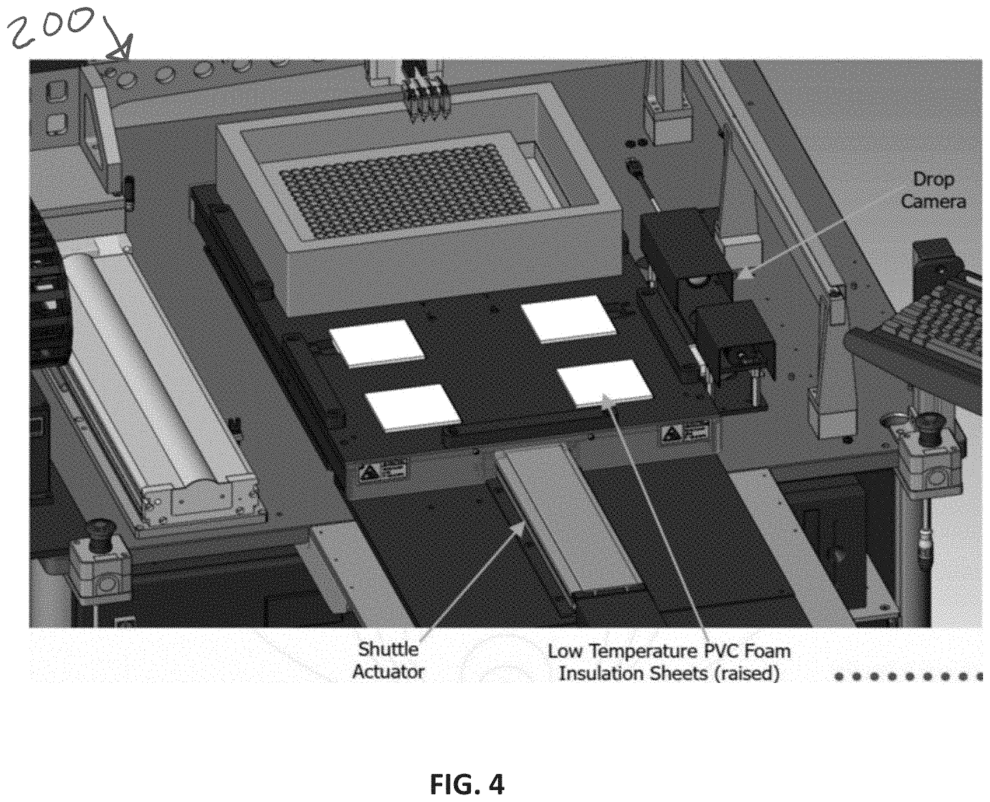

FIG. 2 shows a system 200 that is configured for manufacturing lyobeads. The system 200 can include any of the components of the system 100 or the methods described above. In some configurations, the components of the system 200 can be mounted on a cart. The cart can include wheels and/or adjustable legs for stabilizing the system 200 in place. The cart can include a work area (further shown in FIGS. 3-4). The work area can include one or more insulated boxes or liquid containers. Each of the liquid containers can include a well plate. The well plate can be removable from the liquid containers.

A fluid dispense head can be movable along a motion system over the work area. The fluid dispense head also can be movable into a position such that droplets are dispensed into or through a field of view of a drop camera. The motion system can include a pair of parallel rails on which a transverse rail is mounted. The fluid dispense head can be mounted on a vertical rail and/or the transverse rail. In some configurations, the fluid dispense head can be mounted on a vertical rail, which is mounted on the transfer rail. The double rails can be oriented in an X direction and the transverse rail can be oriented in a Y direction. The vertical rail can be oriented in a Z direction. The transverse rail can be movable in the X direction along the two rails. The fluid dispense head can be movable along the Z direction along the vertical rail and in the Y direction along the transverse rail.

The system 200 can include a computer or PC, including a user interface with a monitor and keyboard. The computer can be used to interact with the control system of the system 200. The computer can be used in conjunction with the drop camera to tune the droplet size produced by the system 200. The computer can provide a readout indicating a volume, a dimension, a diameter, or another parameter of the droplets produced by the fluid dispense head of the system 200. The computer can include an algorithm for providing adjustment to the pressure or the open time of the valve of the fluid dispense head. In some configurations, the computer can include aspects of the control system and can make adjustments automatically based on feedback received from the drop camera. The system 200 can include one or more emergency stops for stopping the motion system and/or the fluid dispense head.

The fluid dispense head shown specifically in the system 200 can be one, two, three, or four dispense heads. In the illustrated configuration, four fluid dispense heads are arranged in a set that moves as a unit. The use of multiple nozzles can increase the throughput of the system 200. In some configurations, an exemplary throughput of the system 200 can be at least 5,000 beads per hour with a single dispense head (channel). In some configurations, an exemplary throughput of the system 200 can be up to 15,000 beads per hour with a single dispense head (channel). In some configurations, an exemplary throughput of the system 200 can be between 5,000 and 15,000 beads per hour per channel. With additional dispense heads, higher total throughput rates can be achieved. In some configurations, an exemplary throughput of the system 200 can be between 20,000 and 60,000 beads per hour with four ganged fluid dispense heads. In some configurations, fluid can be pumped through four separate fluid lines to the dispense heads and the dispense heads can be aligned along four different rows so that the multiple heads can dispense simultaneously, or at intervals, within the corresponding wells. In such configurations, the ganged fluid dispense heads can dispense into the wells four times as fast, keeping in mind the desire for the bead in any given well to freeze prior to subsequent dispensing of another bead into that well.

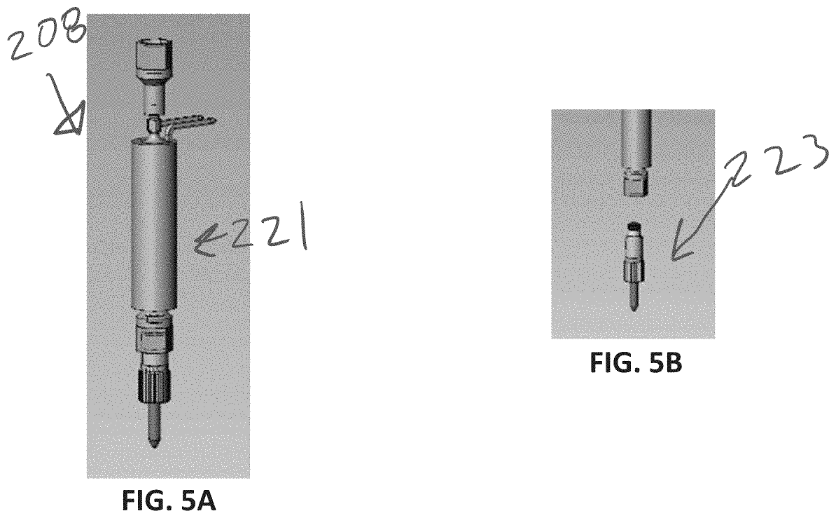

FIGS. 5A and 5B show an embodiment of the dispense head 208. The dispense head 208 can include a removable nozzle 223 that attaches with a valve portion 221. The valve portion 221 can contain a solenoid that opens and closes a valve. The valve portion 221 can be connectable with the removable nozzle 223 via a threaded connection or connector. The valve portion 221 can include inputs for the fluid and/or an air pressure line.

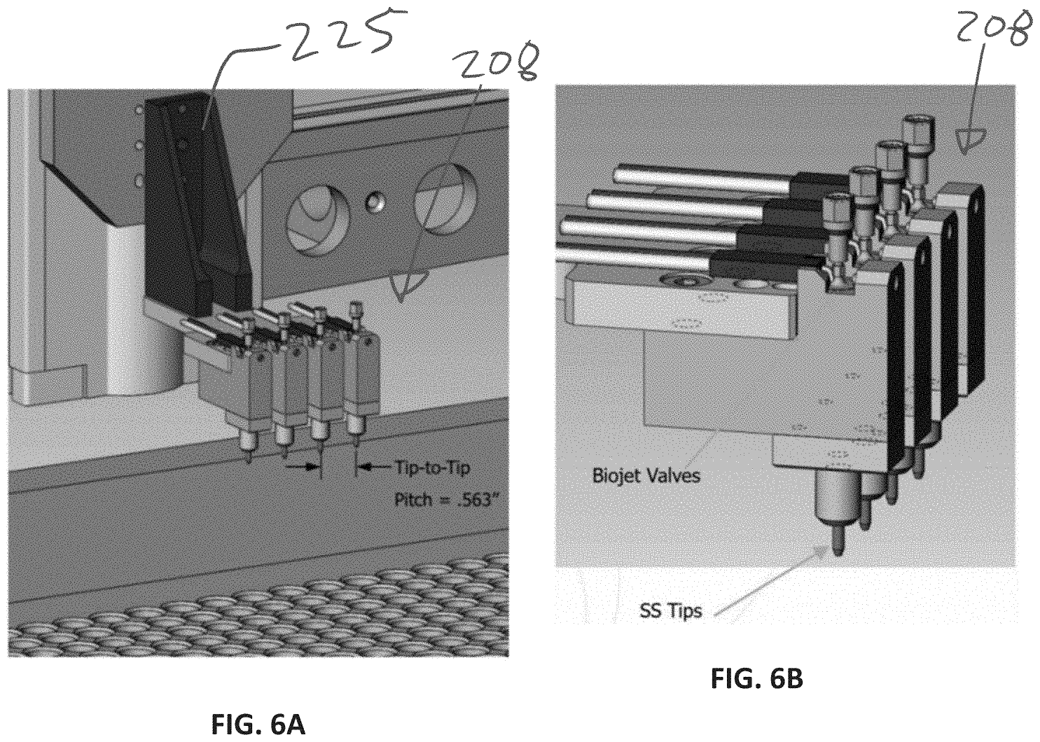

FIGS. 6A and 6B show more detail of the set of four dispense heads 208 of the system 200 attached to a mount 225. The dispense heads 208 can have a tip-to-tip pitch between adjacent dispense heads. The pitch can be based on the volume, throughput, freeze time, and/or rheology of the system 200. An exemplary pitch can be 14.3 mm or 16 mm. Desirably, the pitch range can be between 4.5 mm and 36 mm. The pitch can correspond to a spacing between the wells of a well plate such that each of the four dispense heads aligns with a separate row of wells. An exemplary fluid dispense head 208 is a BioJet fluid dispense head by BioDot, Inc.

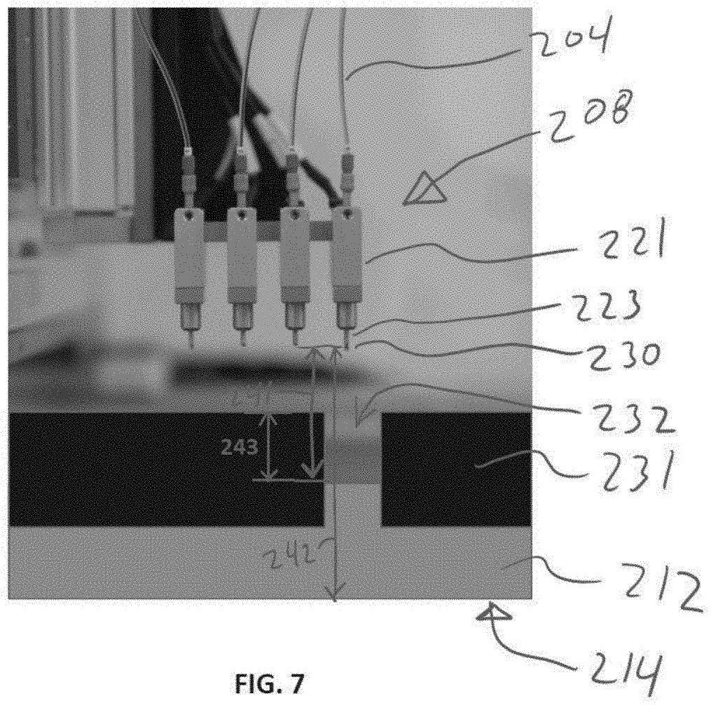

FIG. 7 shows the dispense head 208 in the set of dispense heads. The dispense head 208 can be connected with a fluid line 204. The fluid line 204 can be pressurized by a fluid pressurization system. The valve portion 221 can attach to the removable nozzle 223. The removable nozzle 223 can dispense a droplet 230 through an orifice thereon. The droplet 230 can be aligned with a well 232 of a well plate 231. The well plate 231 can be located within the liquid coolant 212 within the liquid container 214. The orifice of the removable nozzle 223 of the dispense head 208 can be a height 241 above the upper surface of the liquid coolant 212. The orifice of the removable nozzle 223 of the valve portion 221 can be located at height 241 directly above the bottom of the liquid container 214. The height 241 can be sufficiently high to reduce or eliminate the likelihood of freezing within the dispense head 208 and sufficiently low to prevent distortion or pancaking of the droplet 230 as it descends into the liquid coolant 212. The height 242 can be sufficient and/or a depth of the liquid coolant 212 can be sufficient to reduce or eliminate the likelihood of the droplet 230 hitting the bottom of the liquid container 214 and to allow the droplet 230 to freeze at it descends within the liquid coolant 212 contained within the liquid container 214. The well plate 231 can be optional. In such configurations, the droplet 230 can be dispensed directly into the liquid coolant 212 without the presence of discrete wells. Desirably, the height 241 can be from 30 to 100 mm or from 50 to 100 mm. Desirably, the height 242 can be between 50 and 200 mm. Desirably, a height 243 (as defined between a top of the well plate and the top of the liquid coolant 212) can be from 10 mm to 25 mm or from 0 mm to 25 mm. The difference in the level of the liquid coolant 212 can affect the ability of the droplets that are ejected from the dispense head to hit the well while moving the dispense head during OTF dispensing and still avoiding the lip or walls of the wells.

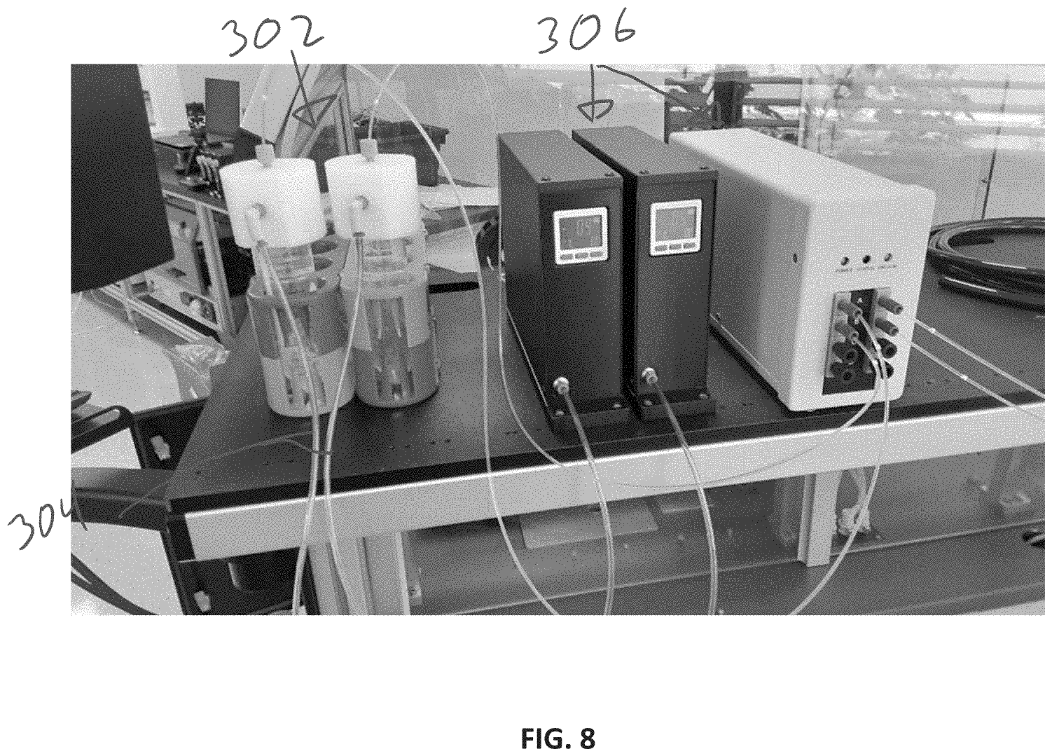

FIG. 8 shows a fluid source 302 that may include homogenizing components, such as mixers or vortexers. The fluid source 302 can be connected with fluid lines 304. The fluid source 302 can be used in conjunction with a fluid system 306.

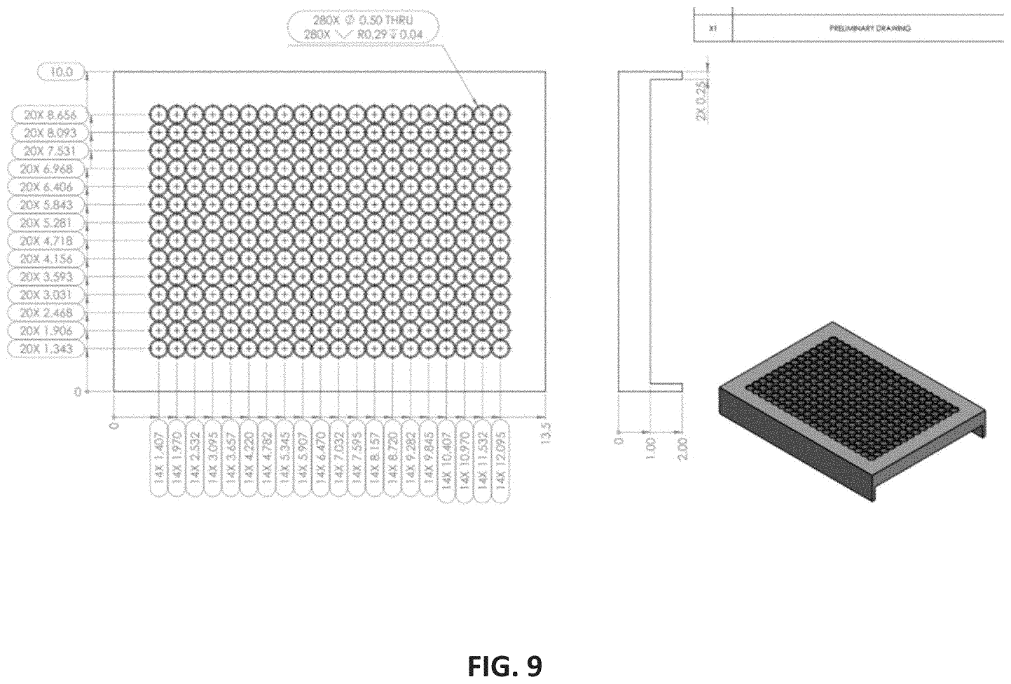

FIG. 9 shows an embodiment of a well plate that includes a plurality of wells. The well plate can include a planar portion including the plurality of wells. The well plate can include one or more legs extending downward from the planar portion. The one or more legs can position the wells above the bottom surface of the container, but the wells still can be at least partially submerged below an upper surface of the liquid coolant. This allows the liquid coolant contained within the liquid container to flow into a bottom of each of the wells without having to individually fill the wells.

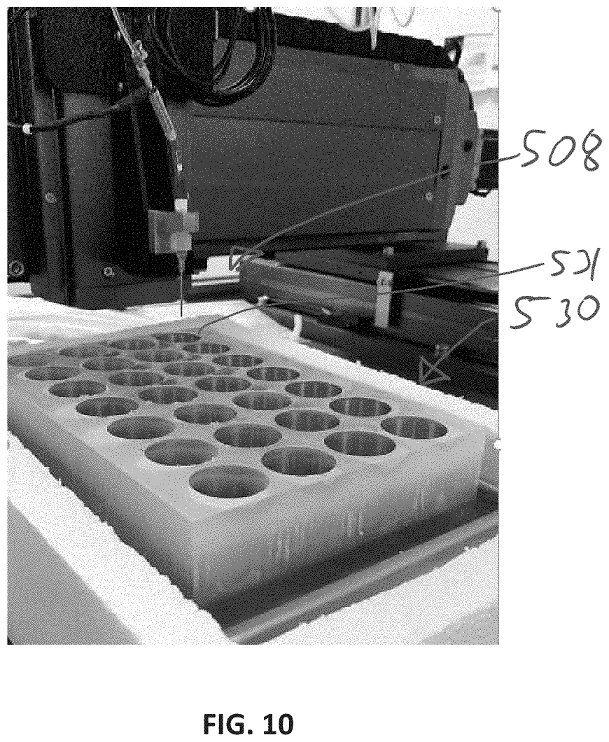

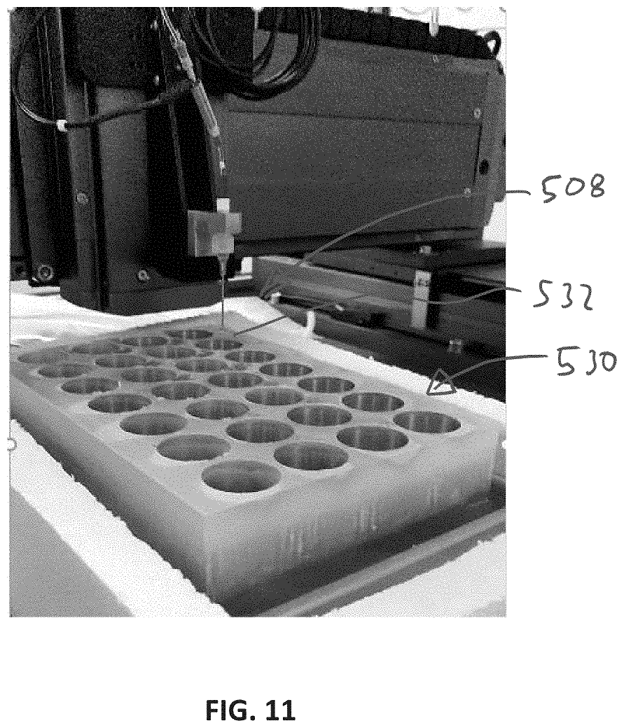

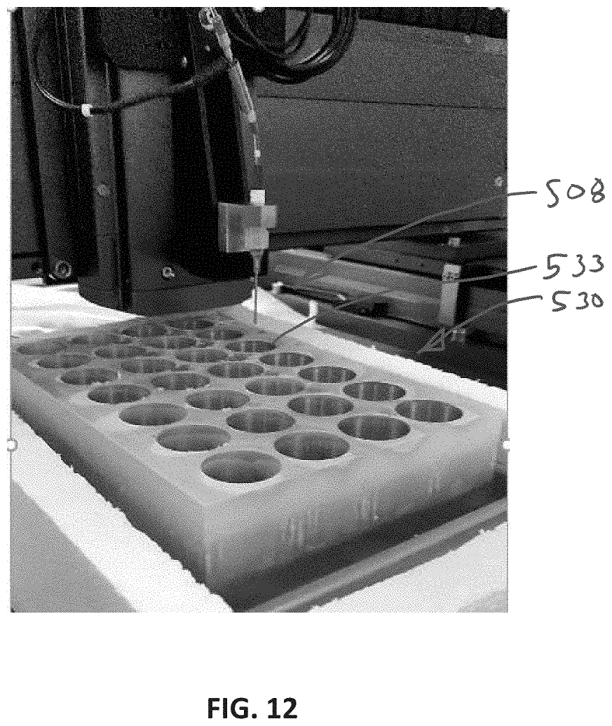

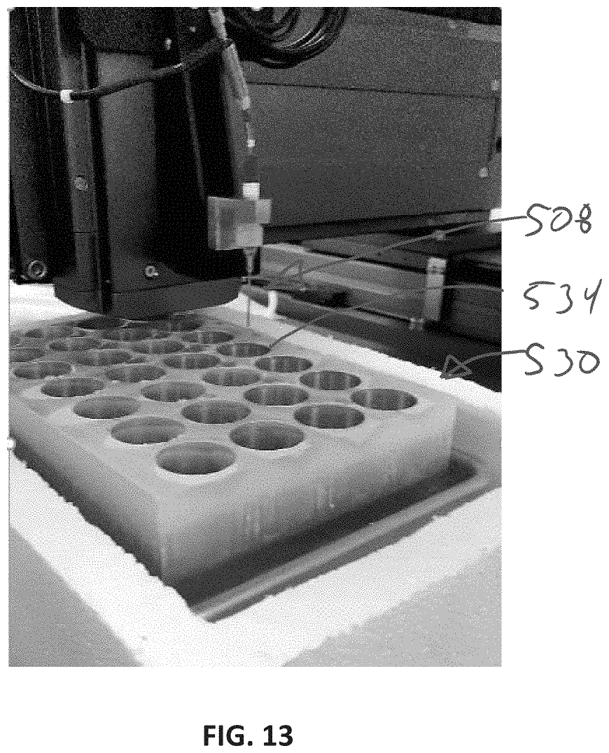

FIGS. 10 through 13 show a dispense head 508 moving along a pathway among at least a first well 531, a second well 532, a third well 533, and a fourth well 534 of a well plate 530 while dispensing a droplet into each of the four wells. The dispense head 508 can continue dispensing into wells along the pathway until a droplet has been dispensed into each of the wells of the well plate 530. The dispense head 508 then can follow the same path or a different path and dispense another droplet into each of the wells of the well plate 530 as long as there is enough time to freeze the first droplets that have been dispensed into the each well when passing along the path for the second pass.

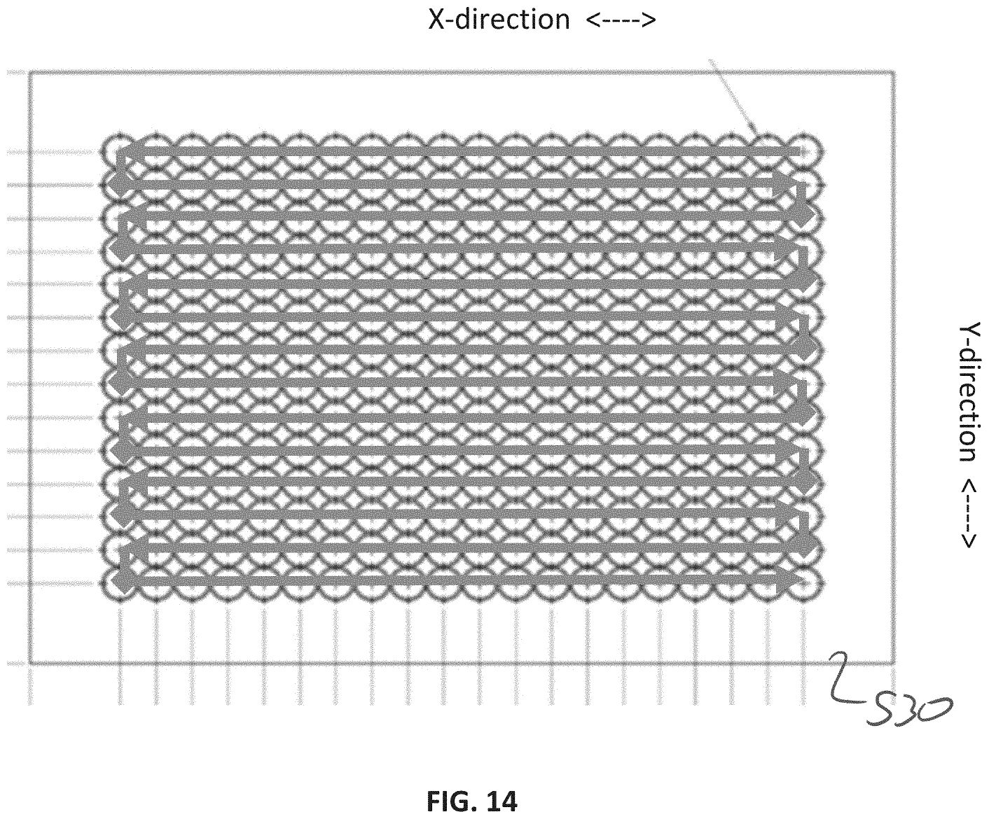

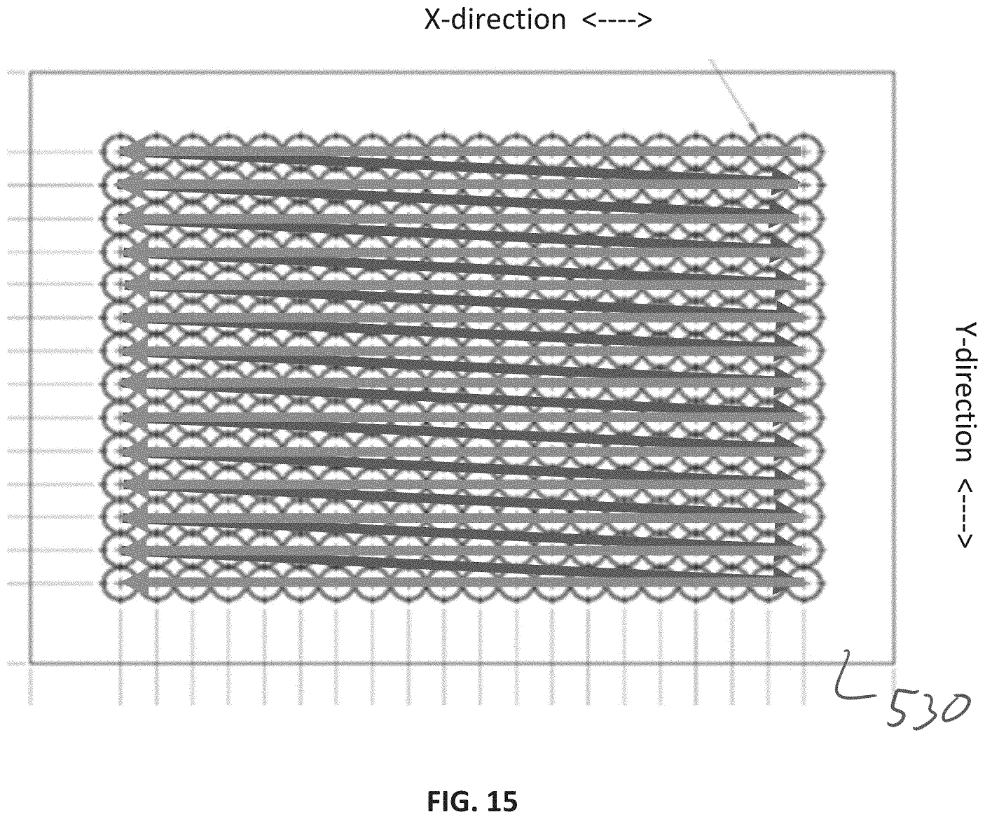

FIG. 14 illustrates a first exemplary pathway for a single dispense head over the well plate 530 in the X and Y directions. FIG. 15 shows an alternative exemplary pathway for a single dispense head over the well plate 530 in the X and Y directions.

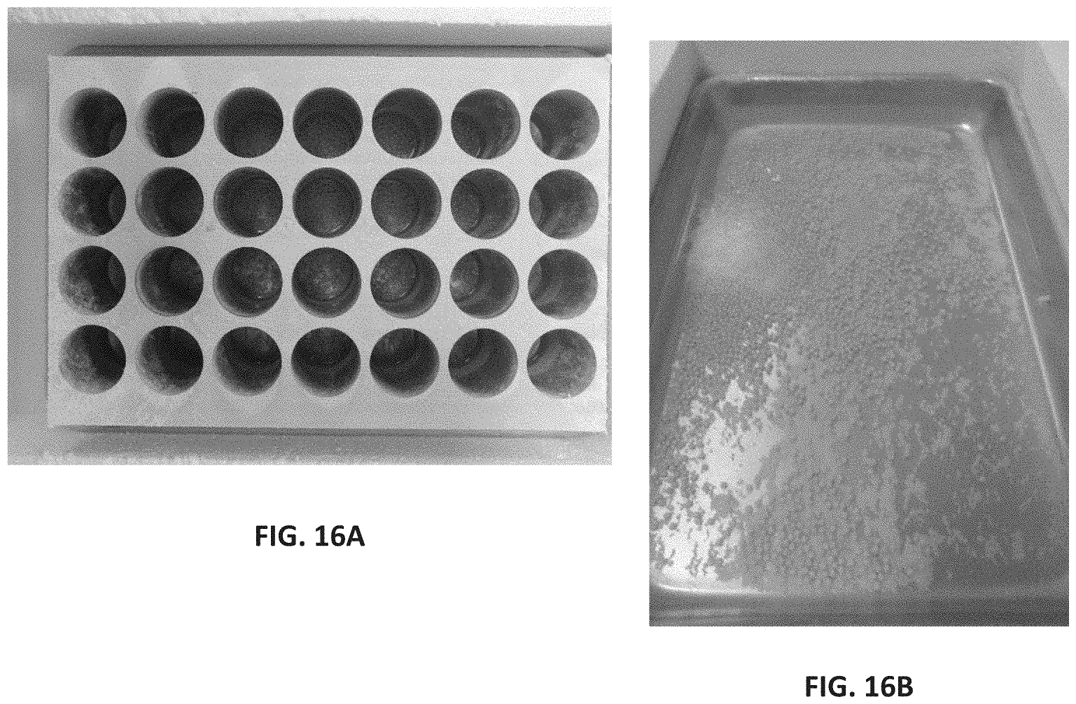

FIG. 16A shows lyobeads that have been formed by being dispensed into the wells of a well plate after the liquid nitrogen is fully boiled away. FIG. 16B shows the well plate removed from the container leaving the formed lyobeads for further processing (e.g., vacuum treatment).

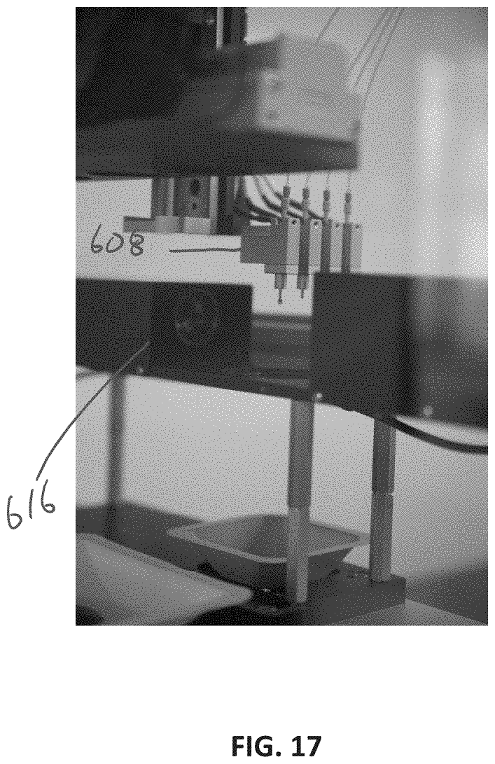

FIG. 17 shows a drop camera 616. A dispense head 608 can be aligned with the field of vision of the drop camera 616 such that a droplet from the dispense head 608 can pass through the field of vision of the drop camera 616. A bowl can be placed below the nozzle of the dispense head 608 for capturing droplets.

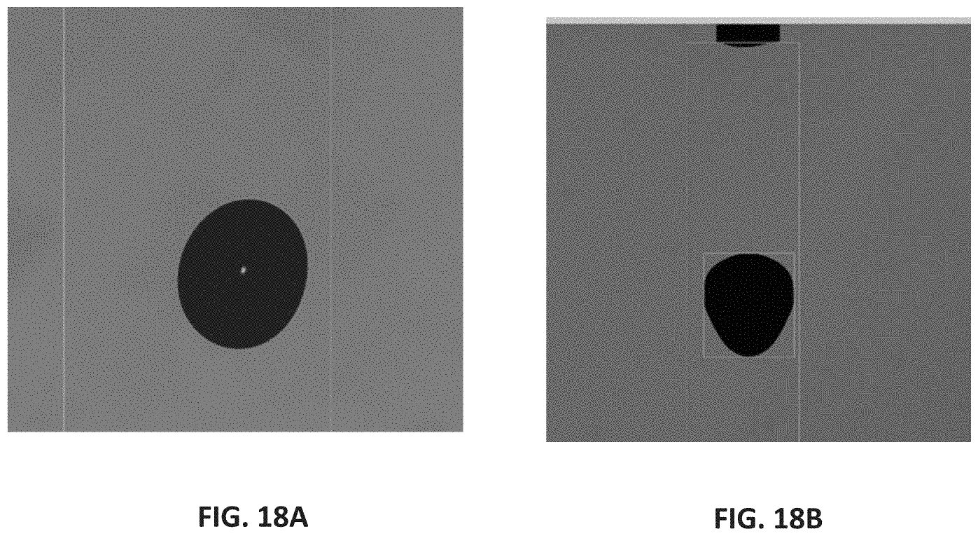

FIG. 18A shows an exemplary spherical droplet in a two-dimensional image captured by the drop camera 616. The droplet can have a volume of 10 μL. A diameter or other measurement of the droplet in the image can be taken. The measurement can correlate to a volume for that droplet. FIG. 18B shows another droplet that is distorted from a spherical shape. The distortion can reduce the likelihood of an accurate measurement or estimation of the volume of the droplet (and, therefore, the final lyobeads). The distortion can be corrected by adjustment of one or more parameters of the system 200, such as the pressure, open time for the valve, and/or the viscosity of the fluid, as discussed above.

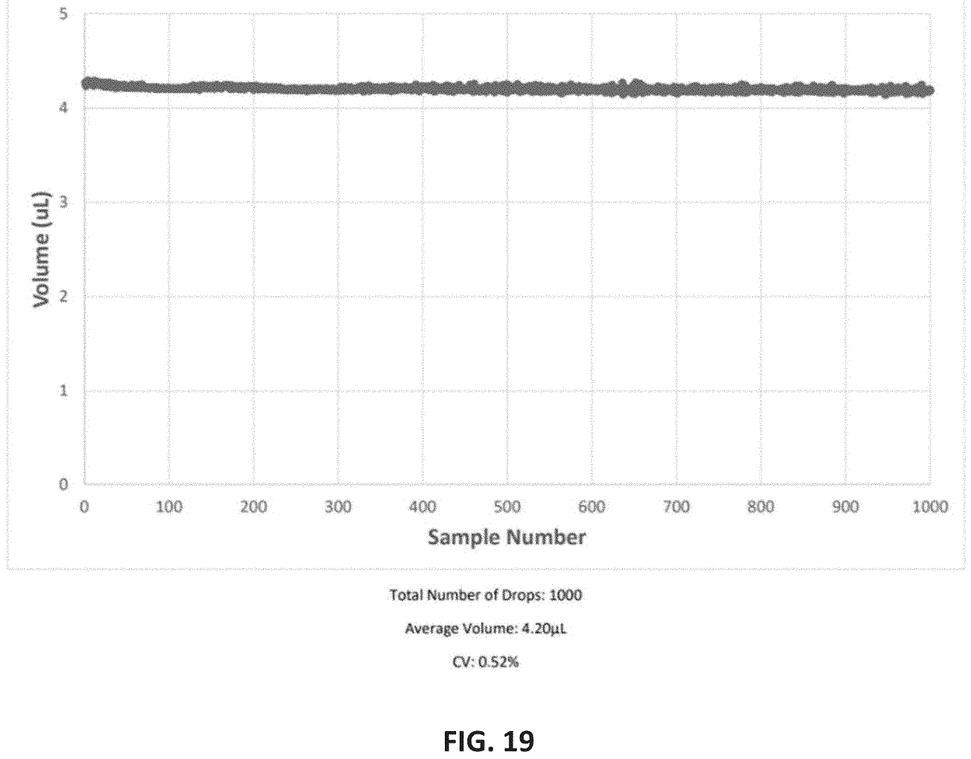

FIG. 19 shows test results showing the volume of 1,000 droplets measured using the drop camera 616.

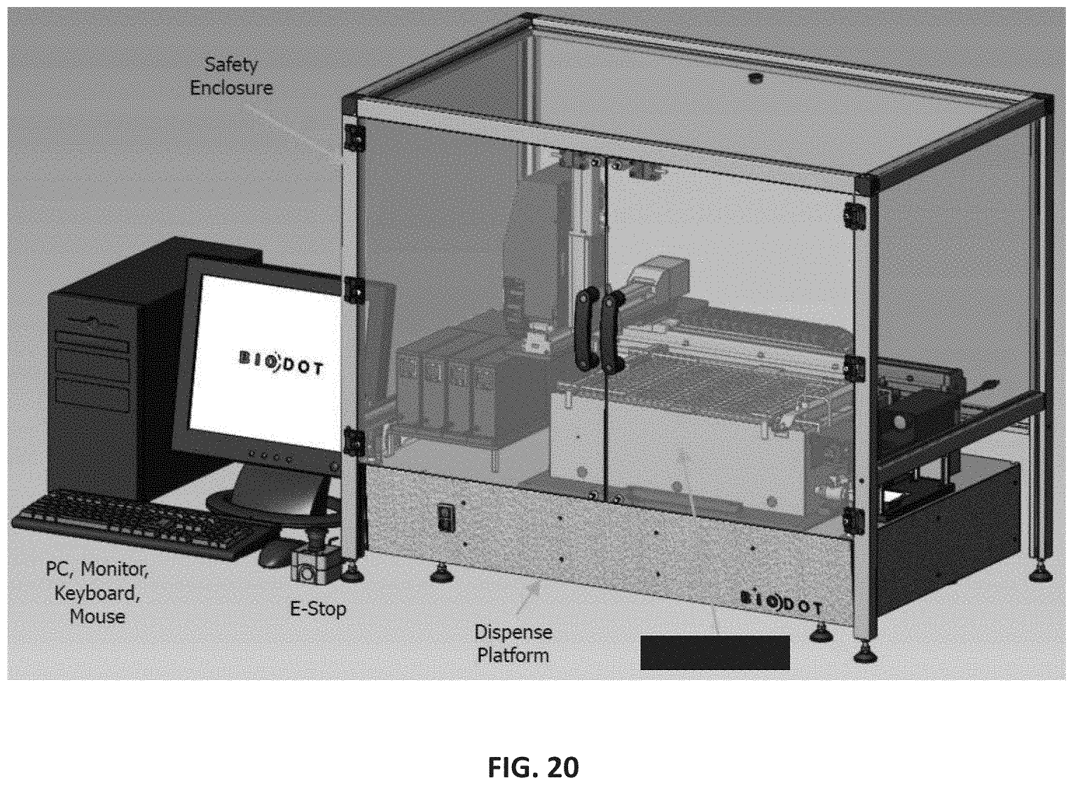

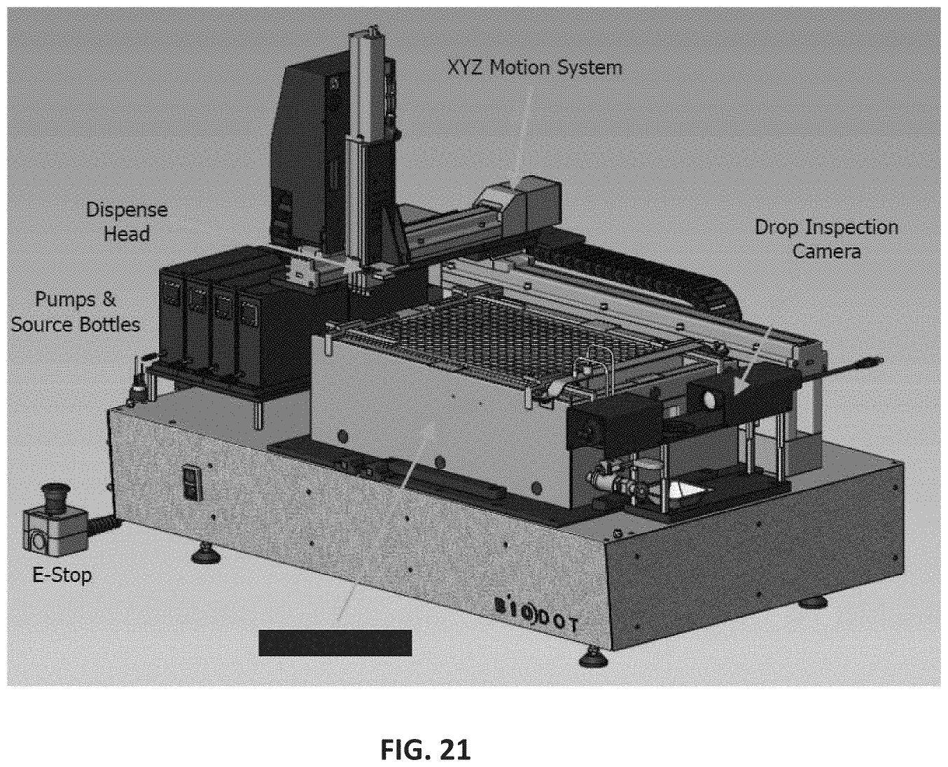

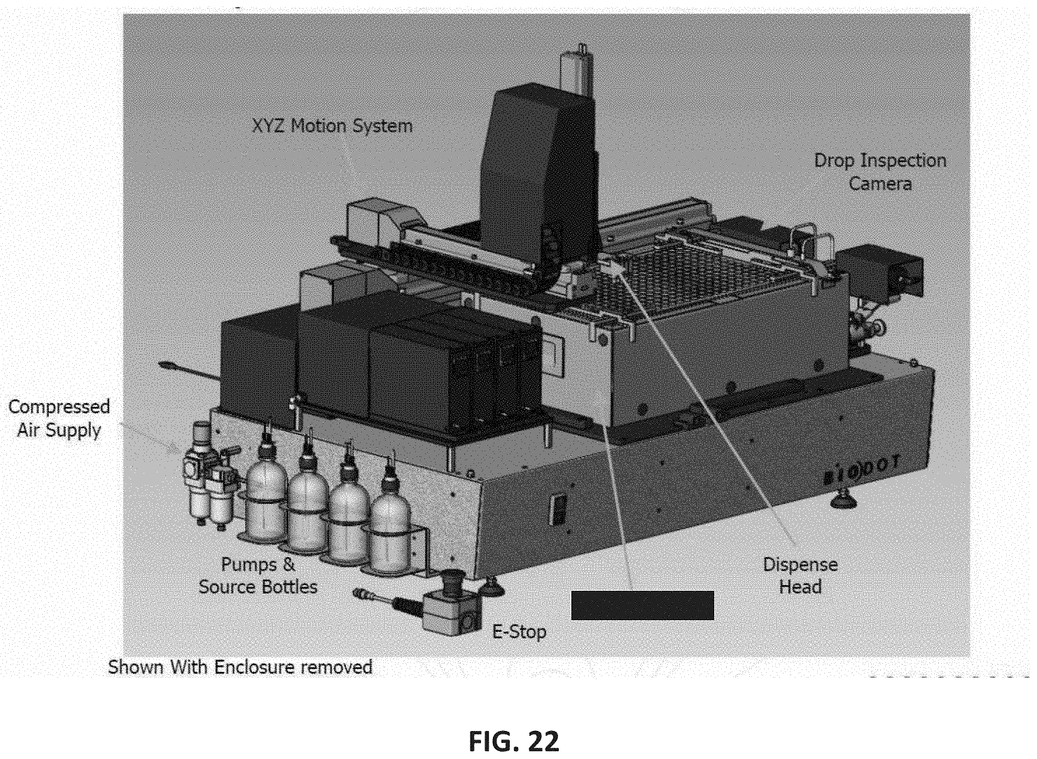

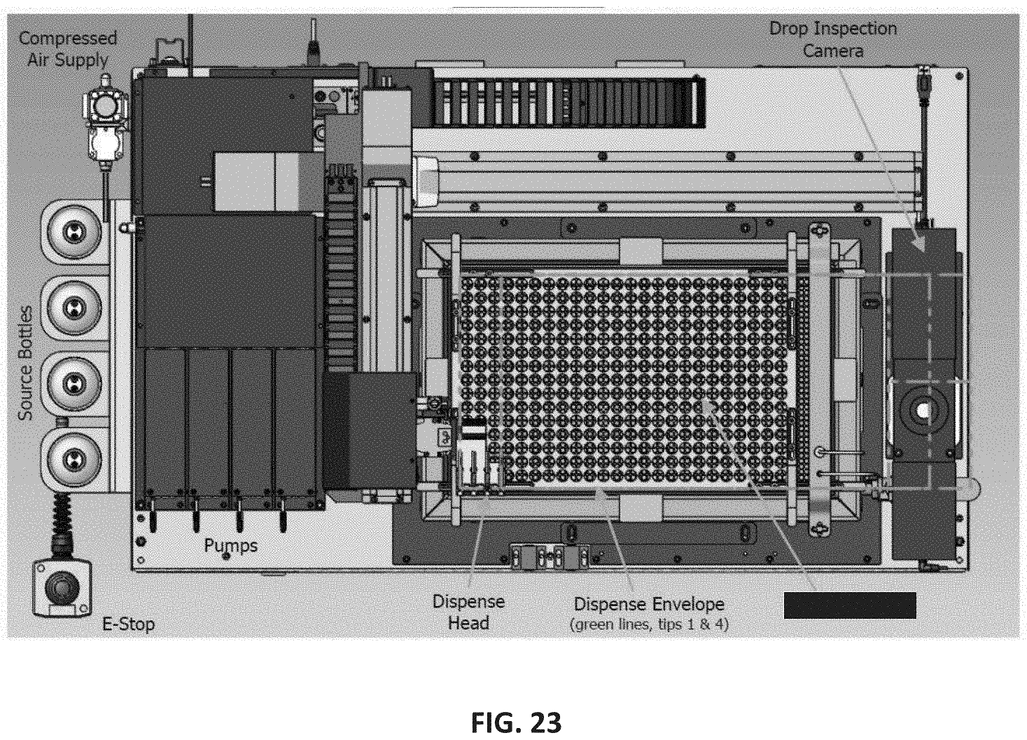

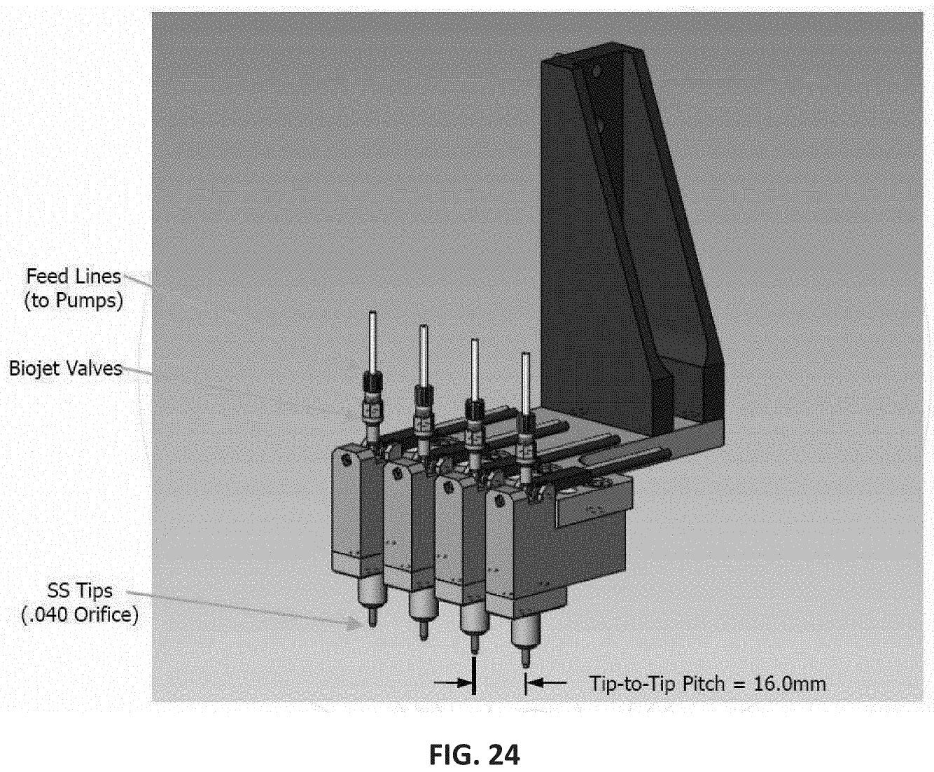

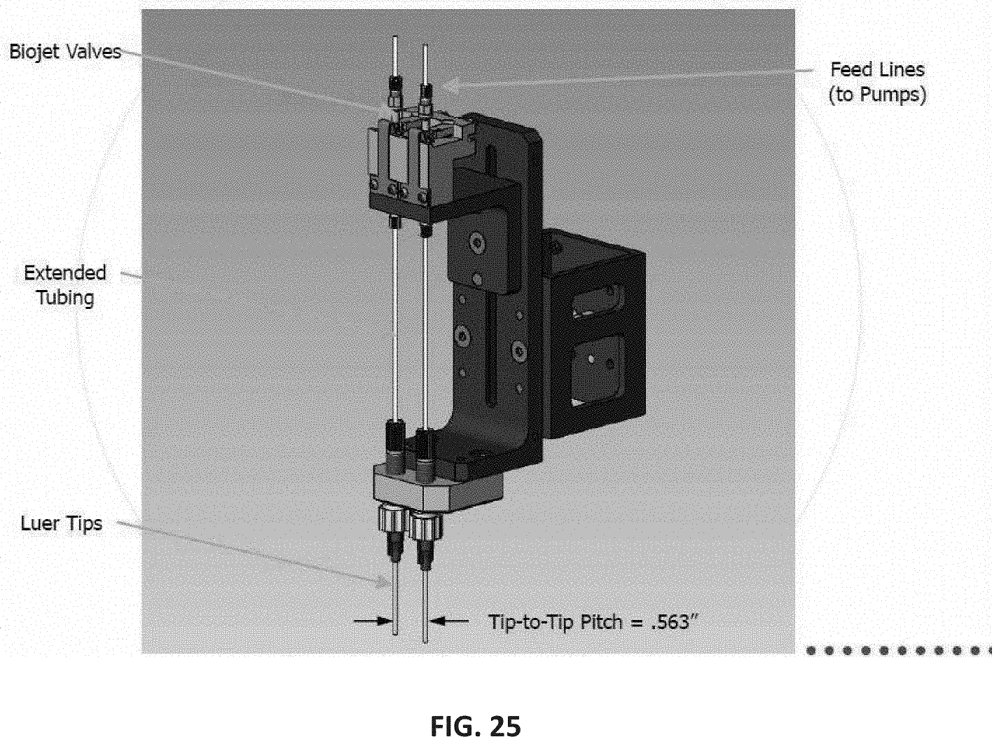

FIGS. 20-24 illustrate another lyophilized bead manufacturing system that is arranged and configured as discussed above. The components discussed above, including the fluid source 102, the fluid lines 104, the fluid pressurization system 106, the fluid dispense head 108, the motion system 110, the liquid coolant 112, the liquid container 114, the drop camera 116, and the control system 118 are configured in a compact arrangement that can be enclosed within an enclosure 700. As shown in FIG. 24, the system 100 can include a set of four fluid dispense heads 108 that include a tip-to-tip pitch of about 16 mm. The tips in the illustrated configuration can be formed from stainless steel and can include any suitable orifice diameter. In some configurations, the orifice diameter is 0.040 mm. FIG. 25 illustrates an additional embodiment of a pair of dispense heads 108. As shown, the dispense heads can include valves, such as BioJet valves at the upper end of the dispense heads 108 with tips at the lower end of the dispense heads 108. The tips can be removably connected to extended tubing that connects the valves to the tips. The tips can be connected through a Luer lock or similar connection. The illustrated pair of dispense heads can feature a tip-to-tip pitch of 0.563 inch. The enclosure can contain all of the moving parts of the system 100. The enclosure includes doors that can be opened to access the liquid container and the well plate such that the liquid container can be filled and refilled with the liquid coolant 112 while the lyobeads can be removed from the system following a production run.

Lyobead Manufacturing Methods

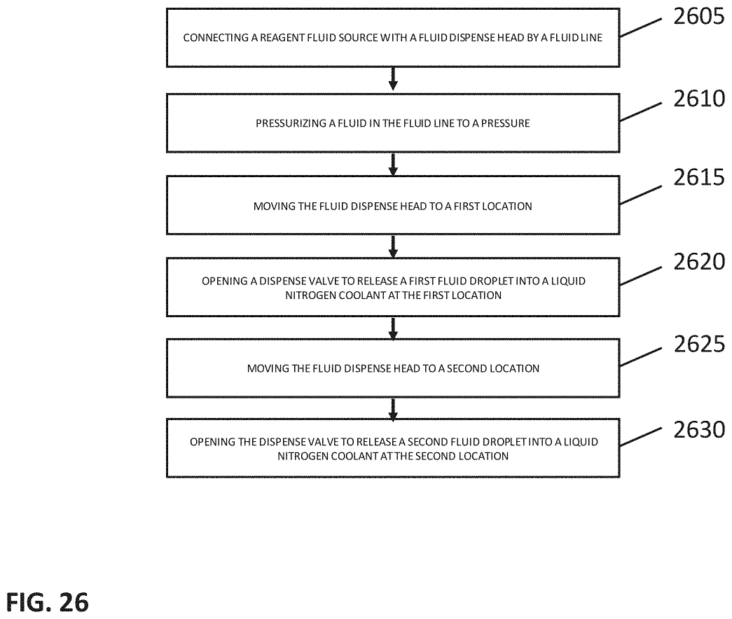

FIG. 26 shows a method of manufacturing a lyobead using the systems 100, 200 and any components described above. At step 2605, a reagent fluid source containing a regent fluid can be connected with a fluid dispense head by a fluid line. The fluid line can be flexible tubing and/or other suitable conduits. In some configurations, the fluid dispense head can include a plurality of dispense heads. The dispense heads can be connected independently with the fluid source.

At step 2610, the fluid line can be connected with a pressure system to provide a pressure to regent fluid in the dispense head. In some configurations, a syringe pump can be employed.

At step 2615, a motion system on which the dispense head is mounted can move the dispense head relative to a first location. A control system that includes a dispensing control board on the fluid dispense head in communication with a motion control board of the motion system can control movement of the motion system. The motion system can move within an X-Y-Z coordinate system.

At step 2620, a dispense valve of the dispense head can be opened for an open time to release a first fluid droplet into liquid coolant at the first location. The first droplet can have a predetermined volume. The movement of the dispense head at step 2615 and/or the opening of the dispense valve can be on-the-fly. For on-the-fly dispensing, the release of the first fluid droplet can be timed to fall into a first well of the well plate containing liquid nitrogen.

At step 2625, the fluid dispense head can move to a second location.

At step 2630, the dispense valve of the dispense head can open for the open time to release a second fluid droplet into liquid coolant at the second location. The second droplet can have the same predetermined volume as the first droplet. The movement of the dispense head at step 2625 and/or the opening of the dispense valve at step 2630 can be on-the-fly. For on-the-fly dispensing, the release of the second fluid droplet can be timed to fall into a second well of the well plate containing liquid nitrogen.

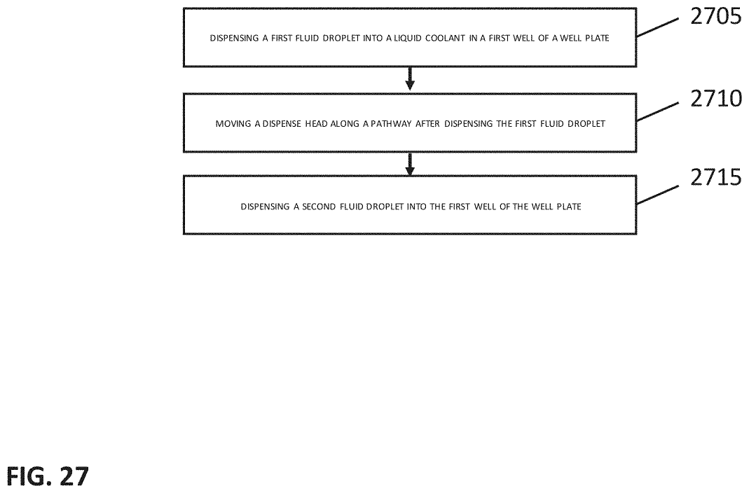

FIG. 27 shows a method of manufacturing a lyobead using the systems 100, 200 and any components described above. At step 2705, a first fluid droplet can be dispensed into a liquid coolant in a first well of a well plate. As discussed above, a reagent fluid source containing a regent fluid can be connected with a fluid dispense head by a fluid line. The fluid line can be any suitable flexible tubing and/or other conduits. In some configurations, the fluid dispense head can include a plurality of dispense heads. The dispense heads can be connected independently with the fluid source. The fluid line can be connected with a pressure system to provide a pressure to regent fluid in the dispense head. In some configurations, a syringe pump can be employed. The dispense head is mounted can move the dispense head relative to a first location. A control system includes a dispensing control board on the fluid dispense head that is in communication with a motion control board of the motion system, which can control movement of the motion system. The motion system can move within an X-Y-Z coordinate system. At the first well, a dispense valve of the dispense head can be opened for an open time to release the first fluid droplet into a liquid coolant within the first well. The first droplet can have a predetermined volume. The movement of the dispense head and/or the opening of the dispense valve can be on-the-fly. For on-the-fly dispensing, the release of the first fluid droplet can be timed to fall into the first well.

At step 2710, the fluid dispense head can move along a pathway prior to dispensing additional single droplets into corresponding wells of the well plate. In this step, the fluid dispense head can be moved to pass over top of additional wells of the well plate. During movement, the fluid dispense head can eject individual droplets such that one droplet lands in each of the wells. The fluid dispense head is moved along the pathway to pass over any wells in which a droplet is intended to be deposited.

Upon completion of the pathway, the dispense head can return to the first well of the well plate at step 2715 and release a second fluid droplet into the liquid coolant at the first well. The second droplet can have the same predetermined volume as the first droplet. A time period or delay period between the first fluid droplet entering the liquid coolant and the second fluid droplet entering the liquid coolant can be sufficiently long to enable the liquid coolant to freeze the first fluid droplet into a solid lyobead before the second fluid droplet enters the liquid coolant within the first well of the well plate. Accordingly, the delay period can be equal to or greater than the freeze time. A typical freeze time can be 90 seconds and the delay period can be 90 seconds or greater, accordingly.

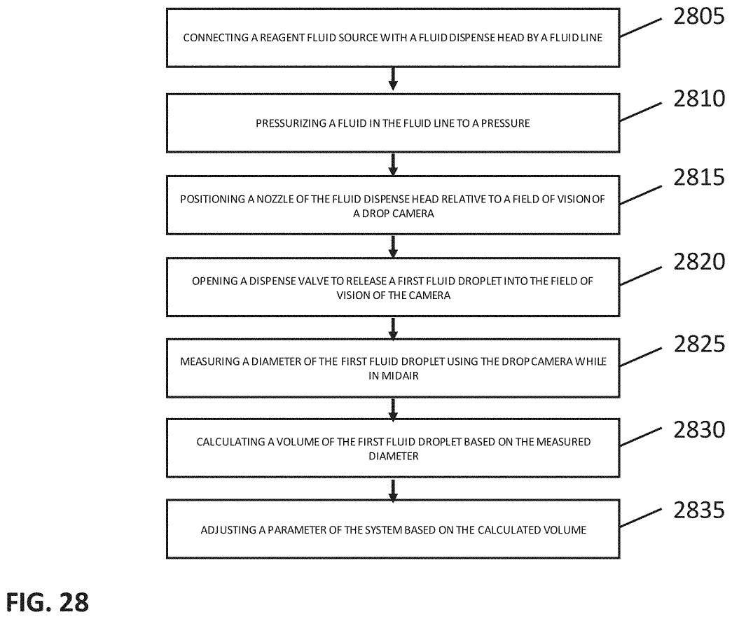

FIG. 28 shows a method of tuning a stable droplet size volume with the systems 100, 200, and any components described above. At step 2805, a reagent fluid source containing a regent fluid can be connected with a fluid dispense head by a fluid line. The fluid line can comprise flexible tubing and/or other conduits. In some configurations, the fluid dispense head can include a plurality of dispense heads. The dispense heads can be connected independently with the fluid source.

At step 2810, the fluid line can be connected with a pressure system to provide a pressure to regent fluid in the dispense head. In some configurations, a syringe pump can be employed. A control system that includes a dispensing control board on the fluid dispense head in communication with a motion control board of the motion system can control movement of the motion system. The motion system can move within an X-Y-Z coordinate system.

At step 2815, a nozzle of the fluid dispense head can be positioned relative to (e.g., vertically above) or in a field of vision of a drop camera.

At step 2820, a solenoid in the fluid dispense head can be actuated to open a dispense valve for an open time and then the dispense valve can be closed such that a first fluid droplet is dispensed.

At step 2825, a diameter of the first fluid droplet can be measured using the drop camera while in midair. The drop camera can capture still images and/or video of the released droplet. The distance between the droplet and the camera can be known. Accordingly, the image of the droplet can be scaled and measured accurately.

At step 2830, a volume of the first fluid droplet can be calculated or estimated based on the measured diameter or other dimension or dimensions of the first fluid drop. Based on the diameter or dimensions of the droplet, the volume thereof can be approximated using an equation for a volume of a sphere and/or any correction factors.

At step 2835, the pressure in the fluid line, the open time of the fluid dispense head, the temperature of the reagent, the height of the nozzle above the drop camera, the volume of the lyobead, and/or other parameter of the system can be adjusted based on the calculated volume compared with a desired volume.

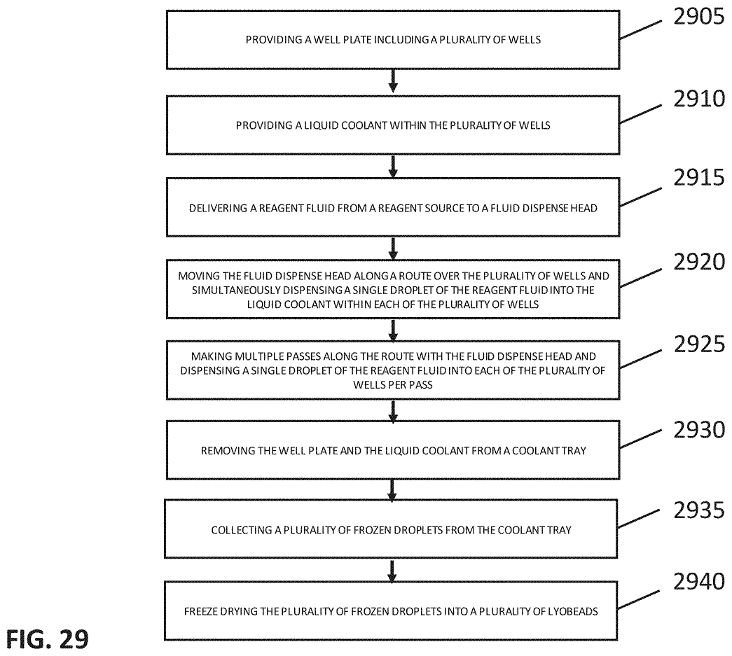

FIG. 29 shows a method of manufacturing a lyobead using the system 100, 200 described above and any component described above. At step 2905, a well plate including a plurality of wells can be provided.

At step 2910, a liquid coolant can be added within each of the plurality of wells.

At step 2915, a reagent fluid from a reagent source can be delivered to a fluid dispense head.

At step 2920, the fluid dispense head can be moved along a route or pathway over each of the plurality of wells into which a droplet is intended to be dispensed and a single droplet of the reagent fluid can be dispensed into the liquid coolant within those wells. Dispensing can be on-the-fly.

At step 2925, the route or pathway can be repeated with subsequent single droplets dispensed into each of the plurality of wells. A delay period between each passage of the dispense head along the pathway can be sufficient to allow the dispensed single droplets to freeze into lyobeads before a subsequent single droplet is dispensed into the same well. Preferably, the time required to complete one pass along the route or pathway is sufficient to allow curing or freezing of the prior droplets such that production can be almost continuous. In some configurations, a throughput of the system can be between 5,000 and 15,000 or at least 5,000 droplets dispensed to produce between 5,000 and 15,000 frozen lyobeads per hour per channel. The above examples describe system and configurations sufficient to achieve such a throughput.

At step 2930, the well plate and the liquid coolant can be removed from a coolant tray, leaving the frozen lyobeads. In some configurations, the lyobeads can be contained within a single tray. In some configurations, the tray or trays can include partitions separating the frozen lyobeads.

At step 2935, the frozen lyobeads can be collected.

At step 2940, the frozen lyobeads can be freeze dried into finished lyobeads using a freeze-drying chamber.

Terms of orientation used herein, such as “top,” “bottom,” “proximal,” “distal,” “longitudinal,” “lateral,” and “end,” are used in the context of the illustrated example. However, the present disclosure should not be limited to the illustrated orientation. Indeed, other orientations are possible and are within the scope of this disclosure. Terms relating to circular shapes as used herein, such as diameter or radius, should be understood not to require perfect circular structures, but rather should be applied to any suitable structure with a cross-sectional region that can be measured from side-to-side. Terms relating to shapes generally, such as “circular,” “cylindrical,” “semi-circular,” or “semi-cylindrical” or any related or similar terms, are not required to conform strictly to the mathematical definitions of circles or cylinders or other structures but can encompass structures that are reasonably close approximations.

Conditional language, such as “can,” “could,” “might,” or “may,” unless specifically stated otherwise, or otherwise understood within the context as used, is generally intended to convey that certain examples include or do not include, certain features, elements, and/or steps. Thus, such conditional language is not generally intended to imply that features, elements, and/or steps are in any way required for one or more examples.

Conjunctive language, such as the phrase “at least one of X, Y, and Z,” unless specifically stated otherwise, is otherwise understood with the context as used in general to convey that an item, term, etc. may be either X, Y, or Z. Thus, such conjunctive language is not generally intended to imply that certain examples require the presence of at least one of X, at least one of Y, and at least one of Z.

The terms “approximately,” “about,” and “substantially” as used herein represent an amount close to the stated amount that still performs a desired function or achieves a desired result. For example, in some examples, as the context may dictate, the terms “approximately,” “about,” and “substantially,” may refer to an amount that is within less than or equal to 10% of the stated amount. The term “generally” as used herein represents a value, amount, or characteristic that predominantly includes or tends toward a particular value, amount, or characteristic. As an example, in certain examples, as the context may dictate, the term “generally parallel” can refer to something that departs from exactly parallel by less than or equal to 20 degrees. All ranges are inclusive of endpoints.

Several illustrative examples of lyophilization systems have been disclosed. Although this disclosure has been described in terms of certain illustrative examples and uses, other examples and other uses, including examples and uses which do not provide all of the features and advantages set forth herein, are also within the scope of this disclosure. Components, elements, features, acts, or steps can be arranged or performed differently than described and components, elements, features, acts, or steps can be combined, merged, added, or left out in various examples. All possible combinations and subcombinations of elements and components described herein are intended to be included in this disclosure. No single feature or group of features is necessary or indispensable.

Certain features that are described in this disclosure in the context of separate implementations can also be implemented in combination in a single implementation. Conversely, various features that are described in the context of a single implementation also can be implemented in multiple implementations separately or in any suitable subcombination. Moreover, although features may be described above as acting in certain combinations, one or more features from a claimed combination can in some cases be excised from the combination, and the combination may be claimed as a subcombination or variation of a subcombination.

Any portion of any of the steps, processes, structures, and/or devices disclosed or illustrated in one example in this disclosure can be combined or used with (or instead of) any other portion of any of the steps, processes, structures, and/or devices disclosed or illustrated in a different example or flowchart. The examples described herein are not intended to be discrete and separate from each other. Combinations, variations, and some implementations of the disclosed features are within the scope of this disclosure.

While operations may be depicted in the drawings or described in the specification in a particular order, such operations need not be performed in the particular order shown or in sequential order, or that all operations be performed, to achieve desirable results. Other operations that are not depicted or described can be incorporated in the example methods and processes. For example, one or more additional operations can be performed before, after, simultaneously, or between any of the described operations. Additionally, the operations may be rearranged or reordered in some implementations. Also, the separation of various components in the implementations described above should not be understood as requiring such separation in all implementations, and it should be understood that the described components and systems can generally be integrated together in a single product or packaged into multiple products. Additionally, some implementations are within the scope of this disclosure.

Further, while illustrative examples have been described, any examples having equivalent elements, modifications, omissions, and/or combinations are also within the scope of this disclosure. Moreover, although certain aspects, advantages, and novel features are described herein, not necessarily all such advantages may be achieved in accordance with any particular example. For example, some examples within the scope of this disclosure achieve one advantage, or a group of advantages, as taught herein without necessarily achieving other advantages taught or suggested herein. Further, some examples may achieve different advantages than those taught or suggested herein.

Some examples have been described in connection with the accompanying drawings. The figures are drawn and/or shown to scale, but such scale should not be limiting, since dimensions and proportions other than what are shown are contemplated and are within the scope of the disclosed invention. Distances, angles, etc. are merely illustrative and do not necessarily bear an exact relationship to actual dimensions and layout of the devices illustrated. Components can be added, removed, and/or rearranged. Further, the disclosure herein of any particular feature, aspect, method, property, characteristic, quality, attribute, element, or the like in connection with various examples can be used in all other examples set forth herein. Additionally, any methods described herein may be practiced using any device suitable for performing the recited steps.

For purposes of summarizing the disclosure, certain aspects, advantages, and features of the inventions have been described herein. Not all, or any such advantages are necessarily achieved in accordance with any particular example of the inventions disclosed herein. No aspects of this disclosure are essential or indispensable. In many examples, the devices, systems, and methods may be configured differently than illustrated in the figures or description herein. For example, various functionalities provided by the illustrated modules can be combined, rearranged, added, or deleted. In some implementations, additional or different processors or modules may perform some or all of the functionalities described with reference to the examples described and illustrated in the figures. Many implementation variations are possible. Any of the features, structures, steps, or processes disclosed in this specification can be included in any example.

In summary, various examples of lyophilization systems and related methods have been disclosed. This disclosure extends beyond the specifically disclosed examples to other alternative examples and/or other uses of the examples, as well as to certain modifications and equivalents thereof. Moreover, this disclosure expressly contemplates that various features and aspects of the disclosed examples can be combined with, or substituted for, one another. Accordingly, the scope of this disclosure should not be limited by the particular disclosed examples described above but should be determined only by a fair reading of the claims.

What is claimed is:

1. A lyobead manufacturing system comprising:
a reagent fluid source containing a fluid;
a fluid dispense head configured to dispense a plurality of spherical droplets of the fluid;
a fluid line connecting the reagent fluid source with the fluid dispense head;
a fluid pressurizing system comprising a pump or a pressure regulator configured to pressurize the reagent fluid source;
a liquid container comprising a liquid coolant; and
a motion system for moving the fluid dispense head in at least two dimensions relative to the liquid container while maintaining a constant height above an upper surface of the liquid coolant.

2. The lyobead manufacturing system of claim 1, wherein the lyobead manufacturing system is configured to dispense the plurality of spherical droplets, each of the plurality of spherical droplets of fluid having a volume from 2 to 50 μL.

3. The lyobead manufacturing system of claim 1 or claim 2 further comprising a chiller configured to adjust a viscosity of the fluid before the fluid reaches the fluid dispense head.

4. The lyobead manufacturing system of any of claims 1-3 further comprising a mixer and/or vortexer to homogenize the fluid before the fluid reaches the fluid dispense head.

5. The lyobead manufacturing system of any of claims 1-4 further comprising a plurality of fluid dispense heads in communication with the reagent fluid source through a corresponding plurality of fluid lines.

6. The lyobead manufacturing system of any of claims 1-5, wherein the fluid dispense head comprises a solenoid valve.

7. The lyobead manufacturing system of claim 6, wherein the solenoid valve is configured to open for an open time to create one of the plurality of spherical droplets and close after expiration of the open time.

8. The lyobead manufacturing system of claim 7, wherein the open time is between 133 μsec and 1 sec.

9. The lyobead manufacturing system of claim 7, wherein closing the solenoid valve provides a clean break off of each of the plurality of spherical droplets.

10. The lyobead manufacturing system of claim 6, wherein fluid dispense head comprises a dispensing nozzle including an aperture having an aperture diameter from 40 μm to 1.5 mm.

11. The lyobead manufacturing system of claim 10, wherein dispensing nozzle is selected from a plurality of dispensing nozzles having different aperture diameters.

12. The lyobead manufacturing system of claim 10, wherein the dispensing nozzle includes a threaded connection with the fluid dispense head.

13. The lyobead manufacturing system of claim 6, wherein the solenoid valve is connected with the fluid pressurizing system through the reagent fluid source.

14. The lyobead manufacturing system of any of claims 1-13, wherein the fluid pressurizing system comprising of a pneumatic and/or syringe-driven pump.

15. The lyobead manufacturing system of any of claims 1-14, wherein the fluid pressurizing system is configured to create a pressure within the lyobead manufacturing system, and the pressure is adjustable between 15 and 300 psi.

16. The lyobead manufacturing system of any of claims 1-15, wherein the fluid pressurizing system is connected with the fluid line.

17. The lyobead manufacturing system of any of claims 1-16, wherein the liquid coolant comprises liquid nitrogen.

18. The lyobead manufacturing system of any of claims 1-17, wherein the liquid container is movable along a shuttle between a dispensing area accessible by the fluid dispense head and a loading/unloading area.

19. The lyobead manufacturing system of any of claims 1-18, wherein the fluid dispense head is mounted on the motion system and moves in X and Y directions within a horizontal plane relative to the liquid container during dispensing of the plurality of spherical droplets.

20. The lyobead manufacturing system of any of claims 1-19 further comprising a well plate including a plurality of wells, the well plate at least partially disposed within the liquid container such that the liquid coolant enters each of the plurality of wells.

21. The lyobead manufacturing system of claim 20, wherein the plurality of wells are through-holes.

22. The lyobead manufacturing system of any of claims 1-21, wherein an orifice of a nozzle of the fluid dispense head is at a height above the liquid coolant configured to allow the plurality of spherical droplets to be spherical just prior to a point of entry into the liquid coolant.

23. The lyobead manufacturing system of any of claims 1-22, wherein a depth of the liquid coolant within the liquid container is sufficient to freeze the plurality of spherical droplets dispensed from the fluid dispense head without impacting a bottom of the liquid container.

24. The lyobead manufacturing system of any of claims 1-23, wherein a height of an orifice of a nozzle of the fluid dispense head above an upper surface of the liquid coolant is sufficient to prevent freezing of the fluid within the fluid dispense head and/or insufficient to allow functionally significant distortion of a droplet shape of the plurality of spherical droplets prior to impact with a surface of the liquid coolant.

25. The lyobead manufacturing system of any of claims 1-24, wherein a combination of a height of an orifice of a nozzle of the fluid dispense head above an upper surface of the liquid coolant and a depth of the liquid coolant prevents the plurality of spherical droplets dispensed from the fluid dispense head from impacting a bottom of the liquid container.

26. The lyobead manufacturing system of any of claims 1-25, wherein a height of an orifice of a nozzle of the fluid dispense head above an upper surface of the liquid coolant is between 50 and 100 mm.

27. The lyobead manufacturing system of any of claims 1-26, wherein the motion system moves the fluid dispense head within a horizontal plane along X and Y directions.

28. The lyobead manufacturing system of claim 27, wherein the motion system moves the fluid dispense head in a Z direction.

29. The lyobead manufacturing system of any of claims 1-28, wherein the motion system includes a transverse rail mounted on a pair of side rails oriented orthogonal to the transverse rail.

30. The lyobead manufacturing system of claim 29 further comprising an adjustable height rail mounted on the transverse rail, the fluid dispense head being mounted on the adjustable height rail.

31. The lyobead manufacturing system of any of claims 1-30 further comprising a drop camera system configured to measure a diameter of each of the plurality of spherical droplets in midair after being dispensed by the fluid dispense head.

32. The lyobead manufacturing system of any of claims 1-31, wherein a stable droplet size of each of the plurality of spherical droplets is adjustable based on tuning a pressure of the fluid pressurizing system and an open time of the fluid dispense head.

33. The lyobead manufacturing system of any of claims 1-32, wherein a maximum stable droplet size and minimum stable droplet size of each of the plurality of spherical droplets based on a diameter of a dispensing nozzle of the fluid dispense head.

34. The lyobead manufacturing system of any of claims 1-33, further comprising a control system configured to:
adjust the fluid pressurizing system to set a dispensing pressure of the fluid in the fluid dispense head; and
move the fluid dispense head along a pathway over the liquid container; and actuate the fluid dispense head to dispense a first fluid droplet into the liquid coolant at a first location along the pathway and actuate the fluid dispense head to dispense a second fluid droplet into the liquid coolant at a second location along the pathway.

35. The lyobead manufacturing system of claim 34, wherein the first fluid droplet and the second fluid droplet are dispensed while moving the fluid dispense head (OTF).

36. The lyobead manufacturing system of any of claims 1-35, further comprising a control system that includes a dispensing control board on the fluid dispense head in communication with a motion control board of the motion system.

37. A method of manufacturing a lyobead using a lyobead manufacturing system, the method comprising:
using the lyobead manufacturing system of any of claims 1-36 to dispense a first fluid droplet into a liquid coolant through a first well of a well plate;
moving a dispense head along a pathway; and
using the lyobead manufacturing system, dispensing a second fluid droplet into the liquid coolant through the first well of a well plate;
wherein a delay period between the first fluid droplet entering the liquid coolant and the second fluid droplet entering the liquid coolant is at least sufficiently long to enable the liquid coolant to freeze the first fluid droplet into a first lyobead before the second fluid droplet enters the liquid coolant within the first well of the well plate.

38. The method of manufacturing a lyobead of claim 37, wherein the first fluid droplet and the second fluid droplet are dispensed through a nozzle of the dispense head.

39. The method of manufacturing a lyobead of claim 38, further comprising:
dispensing each of a first plurality of fluid droplets into a corresponding well of a plurality of wells of the well plate while moving the dispense head along the pathway in a first pass.

40. The method of manufacturing a lyobead of claim 39, further comprising:
dispensing each of a second plurality of fluid droplets into the corresponding well while moving the dispense head along the pathway in a second pass.

41. The method of manufacturing a lyobead of claim 40, wherein the delay period applies between dispensing each of the first plurality of fluid droplets and the second plurality of fluid droplets into corresponding wells is sufficiently long to enable the liquid coolant to freeze the first plurality of fluid droplets into lyobeads before the second plurality of fluid droplets enter the liquid coolant.

42. A method of manufacturing a lyobead, comprising:
connecting a reagent fluid source with a fluid dispense head by a fluid line;
pressurizing a fluid in the fluid line to a pressure;
moving the fluid dispense head to a first location;
actuating a solenoid in the fluid dispense head to open a dispense valve for an open time to release a first fluid droplet into a liquid nitrogen coolant at the first location, and closing the dispense valve;
moving the fluid dispense head to a second location; and
actuating the solenoid in the fluid dispense head to open the dispense valve for the open time to release a second fluid droplet into the liquid nitrogen coolant at the second location, and closing the dispense valve;
wherein the pressure in the fluid line and the open time of the fluid dispense head are configured to release a stable droplet size from a nozzle of the dispense valve for first and second fluid drops.

43. The method of manufacturing a lyobead of claim 42 further comprising dispensing the first fluid droplet and the second fluid droplet while moving the fluid dispense head.

44. The method of manufacturing a lyobead of any of claims 42 and 43, further comprising dispensing the first fluid droplet and the second fluid droplet while moving the fluid dispense head (OTF).

45. The method of manufacturing a lyobead of any of claims 42-44, further comprising the first fluid droplet being dispensed through a first well of a well plate and the second fluid droplet being dispensed through a second well of the well plate.

46. The method of manufacturing a lyobead of claim 45 further comprising dispensing a third fluid droplet through the first well after at least a delay period sufficient for the first fluid droplet to freeze within the liquid nitrogen coolant.

47. The method of manufacturing a lyobead of any of claims 42-46, further comprising adjusting a height of the fluid dispense head above the liquid nitrogen coolant to prevent distortion of the first and second fluid drops.

48. The method of manufacturing a lyobead of any of claims 42-47, further comprising adjusting a depth of the liquid nitrogen coolant to prevent the first fluid droplet and the second fluid droplet from impacting a bottom of a container for the liquid nitrogen coolant.

49. The method of manufacturing a lyobead of any of claims 42-47, further comprising adjusting a depth of the liquid nitrogen coolant relative to a top of a well plate to facilitate the first fluid droplet and the second fluid droplet entering the liquid nitrogen coolant.

50. A method of tuning a stable droplet size volume for a lyobead manufacturing system, the method comprising:
connecting a reagent fluid source with a fluid dispense head by a fluid line;
pressurizing a fluid in the fluid line to a pressure;
positioning a nozzle of the fluid dispense head relative to a field of vision of a drop camera;
actuating a solenoid in the fluid dispense head to open a dispense valve for an open time to release a first fluid droplet into the field of vision and closing the dispense valve;
measuring a diameter of the first fluid droplet using the drop camera while in midair;
calculating a volume of the first fluid droplet based on the measured diameter of the first fluid droplet; and
adjusting a parameter of the lyobead manufacturing system based on a comparison of the calculated volume with a desired volume.

51. A method of lyobead manufacturing, comprising:
providing a well plate including a plurality of wells;
providing a liquid coolant within each of the plurality of wells; delivering a reagent fluid from a reagent source to a fluid dispense head; and
moving the fluid dispense head along a route over each of the plurality of wells and simultaneously dispensing a single droplet of the reagent fluid into the liquid coolant within each of the plurality of wells (OTF);
wherein a droplet throughput rate of the fluid dispense head is between 5,000 and 15,000 droplets per hour per channel.

52. The method of claim 51, wherein moving the fluid dispense head includes making multiple passes along the route and dispensing the single droplet of the reagent fluid into each of the plurality of wells per pass.

53. The method of claim 52, wherein a delay period of the fluid dispense head making the multiple passes is at least sufficiently long to enable the liquid coolant to freeze the dispensed single droplets before receiving dispensed single droplets in each of the plurality of wells in subsequent passes.

54. The method of claim 53, wherein a diameter of each of the plurality of wells is from 0.5 to 2 inches.

55. The method of claim 53, wherein a width or diameter of each of the plurality of wells is from 10 to 25 mm in a direction of travel of the fluid dispense head and a width or diameter of each of the plurality of wells is from 5 to 15 mm in a direction transverse to the direction of travel of the fluid dispense head and a stable droplet size of each of the dispensed single droplets is between 2 μL-50 μL.

56. The method of claim 53, wherein a width or diameter of each of the plurality of wells is from 1 to 25 mm in a direction of travel of the fluid dispense head and a width or diameter of each of the plurality of wells is from 1 to 15 mm in a direction transverse to the direction of travel of the fluid dispense head and a stable droplet size of each of the dispensed single droplets is less than 2 μL.

57. The method of any of claims 51-56, wherein the fluid dispense head includes a plurality of valves, each of the plurality of valves spaced apart from adjacent one of the plurality of valves by a pitch distance, and the plurality of wells arranged in rows spaced apart by the pitch distance.

58. The method of any of claims 51-54, wherein a stable droplet size of each of the dispensed single droplets is between 2 μL-50 μL.

59. The method of any of claims 51-58, wherein a nozzle of the fluid dispense head above an upper surface of the liquid coolant and a depth of the liquid coolant prevents the dispensed single droplets dispensed from the fluid dispense head from impacting a bottom of any of the plurality of wells.

60. The method of any of claims 51-59, wherein the fluid dispense head moves within along rails in an X-Y coordinate plane.

61. The method of any of claims 51-60, further comprising:
removing the well plate and the liquid coolant from a coolant tray; collecting a plurality of frozen droplets from the coolant tray; and
freeze drying the plurality of frozen droplets into a plurality of lyobeads.

62. The method of any of claims 51-61, wherein a table speed of the liquid coolant is from 10 to 150 mm/sec.

63. The method of any of claims 51-62, wherein a drop velocity of the fluid dispense head is from 100 to 3000 mm/sec.

64. The method of any of claims 51-63, wherein a droplet ejection frequency is from 2 to 100 Hz.

65. The method of any of claims 51-64, wherein the plurality of wells comprise between 50 and 400 wells.

66. The method of any of claims 51-65, wherein a height of a well plate of the plurality of wells and a surface of the liquid coolant is from 10 to 25 mm.

67. The method of any of claims 51-66, wherein a width or diameter of each of the plurality of wells is from 1 to 25 mm in a direction of travel of the fluid dispense head and a width or diameter of each of the plurality of wells is from 1 to 15 mm in a direction transverse to the direction of travel of the fluid dispense head.

68. The method of any of claims 51-67, wherein a height of a nozzle of the fluid dispense head above a surface of the liquid coolant is from 50 to 100 mm.

69. The method of any of claims 53-56, wherein the delay period is between 10 and 90 seconds.

70. The method of any of claims 57-68, wherein a delay period of the fluid dispense head making multiple passes is between 10 and 90 seconds.

71. The method of any of claims 69 and 70, wherein the delay period is approximately 90 seconds.
